(19) United States
(12) Patent Application Publication
(10) Pub. No.: US 2025/0253082 A1
(43) Pub. Date: Aug. 7, 2025

(54) ADDITIVELY MANUFACTURED MONOCRYSTALLINE REBCO SUPERCONDUCTORS AND FABRICATION METHODS OF SAME

(71) Applicants: NORTHWESTERN UNIVERSITY, Evanston, IL (US); FERMI RESEARCH ALLIANCE, LLC, Batavia, IL (US)

(72) Inventors: Cristian Boffo, Batavia, IL (US); David C. Dunand, Evanston, IL (US); Dingchang Zhang, Evanston, IL (US)

(21) Appl. No.: 19/044,744

(22) Filed: Feb. 4, 2025

Related U.S. Application Data
(60) Provisional application No. 63/550,705, filed on Feb. 7, 2024.

(51) Int. Cl. H01F 6/06; B33Y 10/00; B33Y 40/20; B33Y 70/10; B33Y 80/00

(52) U.S. Cl. CPC H01F 6/06; B33Y 10/00; B33Y 40/20; B33Y 70/10; B33Y 80/00

(57) ABSTRACT

This invention discloses a monocrystalline superconductor and a method for fabricating the monocrystalline superconductor. The method includes providing an ink comprising a mixture of powders of RE₂O₃, BaCO₃, and a Ba and/or Cu precursor with a binder and a solvent; extruding the ink into micro-lattices layer by layer to form a three dimension (3D)-printed object with a desired architecture; sintering the 3D-printed object to obtain a polycrystalline 3D-printed object comprising REBa₂Cu₃O₇₋ₓ(RE123)+RE₂BaCuO₅ (RE211); and performing single-crystal growth of monocrystalline structures from the polycrystalline 3D-printed object to fabricate the monocrystalline superconductor, wherein RE represents a rare-earth element selected from the group consisting of Y, La, Sm, Nd, Gd, and Eu.

### CROSS-REFERENCE TO RELATED PATENT APPLICATION

This application claims priority to and the benefit of U.S. Provisional Application Ser. No. 63/550,705, filed Feb. 7, 2024, which is incorporated herein in its entirety by reference.

### STATEMENT AS TO RIGHTS UNDER FEDERALLY-SPONSORED RESEARCH

This invention was made with government support under Grant No. 677927//DE-AC02-07C H11359 awarded by the Department of Energy. The government has certain rights in the invention.

### FIELD OF THE INVENTION

The present invention generally relates to the material science, particularly to additively manufactured monocrystalline REBCO superconductors and fabrication methods of the same.

### BACKGROUND OF THE INVENTION

The background description provided herein is to present the context of the invention generally. The subject matter discussed in the background of the invention section should not be assumed to be prior art merely due to its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions. Work of the presently named inventors, to the extent it is described in the background of the invention section, as well as aspects of the description that may not otherwise qualify as prior art at the time of filing, are neither expressly nor impliedly admitted as prior art against the invention.

Yttrium barium copper oxide YBa₂Cu₃O₇₋ₓ (YBCO or Y123) is the original high-temperature cuprate oxide with a superconducting critical temperature (T_{c}˜93 K) well above the boiling point of liquid nitrogen (77 K), enabling various transformational applications, both for existing (e.g., magnetic resonance imaging, nuclear magnetic resonance) and future (e.g., energy storage, fusion power plants, maglev trains). Additive manufacturing of monocrystalline YBCO superconductors not only offers greater design flexibility for existing applications but also paves the way for new innovations. The architectural freedom of additive manufacturing enables optimized magnetic field distribution, efficient cooling to sustain the superconducting state, and a lightweight structure for levitation applications. Additive manufacturing of ceramics, like YBCO, currently produces only a polycrystalline microstructure when followed by conventional sintering. However, grain boundaries are weak links for current transport in YBCO, principally because the coherence length (related to the characteristic size of a Cooper pair) of YBCO is too short to allow supercurrent to span over the structural disorder caused by a grain boundary. Therefore, YBCO with a polycrystalline microstructure typically has a low critical current density (˜5×10¹ A·cm⁻², 77K, zero field) due to the presence of numerous grain boundaries. In contrast, forming a single-crystal microstructure effectively eliminates these grain boundaries, leading to a significant increase in critical current density (˜4.5×10⁴ A·cm², 77K, H∥c, zero field). Therefore, YBCO superconductors are mainly used as coated tapes/wires where the thin YBCO film is epitaxially grown on a biaxially textured conductor substrate which can achieve a high critical current density (more than 3×10⁶ A/cm² at 77K). However, these ceramic-like tapes cannot be bent over a radius below 2-10 mm without degrading their critical current, nor can they be shaped in complex 3D-objects. Furthermore, even for superconducting tapes, joints between strands to achieve longer length or larger width induce residual resistance. This severely limits applications where complex 3D architectures are needed, such as microwave cavities with minimal gaps between tapes and undulator with short periods. In bulk form, YBCO (specifically: Y123+Y₂BaCuO₅(Y211)) single crystals (single grain or single domain) can be grown by the top-seeded melt growth or top-seeded infiltration growth method. These bulk YBCO single crystals can trap large magnetic fields and can potentially substitute iron-based permanent magnets, e.g., for superconducting motors or generators. However, they are currently limited to simple cylinder or cuboid shapes.

Therefore, a heretofore unaddressed need exists in the art to address the aforementioned deficiencies and inadequacies.

### SUMMARY OF THE INVENTION

In view of the foregoing, this invention discloses a novel approach to grow a single crystal from a 3D-ink-printed REBCO architectures (with or without additional Origami folding) with an excellent shape fidelity to achieve a nearly hundred-fold improvement in critical current density as compared to prior polycrystalline YBCO objects created by AM.

In one aspect, the invention relates to a method for fabricating a monocrystalline superconductor, comprising providing an ink comprising a mixture of powders of RE₂O₃, BaCO₃, and a Ba and/or Cu precursor with a binder and a solvent; extruding the ink into micro-lattices layer by layer to form a three dimension (3D)-printed object with a desired architecture; sintering the 3D-printed object to obtain a polycrystalline 3D-printed object comprising REBa₂Cu₃O₇₋ₓ(RE123)+RE₂BaCuO₅ (RE211); and performing single-crystal growth of monocrystalline structures from the polycrystalline 3D-printed object to fabricate the monocrystalline superconductor, wherein RE represents a rare-earth element selected from the group consisting of Y, La, Sm, Nd, Gd, and Eu.

In one embodiment, the Ba- and/or Cu-precursor comprises CuO, BaO, Cu₂O, CuCO₃·Cu(OH)₂, Cu₂(OH)₃Cl, CuCl₂, CuNO₃, CuSO₄, or a combination thereof.

In one embodiment, the ink comprises a composition of RE123+(10-50) wt. % RE211+(0-5) wt. % (CeO₂ or Pt) formed by mixing powders of RE₂O₃, BaCO₃, the Ba and/or Cu precursor, and (CeO₂ or Pt) with the binder and the solvent.

In one embodiment, the ink composition comprises 69 wt. % REBa₂Cu₃O₇₋ₓ+30 wt. % RE₂BaCuO₅+1 wt. % CeO₂.

In one embodiment, the method further comprises performing rapid evaporation of the solvent after said extruding the ink to prevent slumping and sagging of printed filaments in the 3D-printed object.

In one embodiment, the binder comprises poly-lactic-co-glycolic-acid (PLGA), or polystyrene (PS), or polyethylene oxide (PEO), and the solvent comprises dichloromethane (DCM).

In one embodiment, the ink further comprises a plasticizer and/or a surfactant.

In one embodiment, the plasticizer comprises dibutyl phthalate (DBP), and the surfactant comprises ethylene glycol butyl ether (EGBE).

In one embodiment, said sintering the 3D-printed object comprises de-binding the 3D-printed object at temperature in a range of 100-400° C. under flowing Ar-1 mol. % O₂; and heating the de-bonded 3D-printed object at temperature in a range of 750-1100° C. under flowing O₂.

In one embodiment, said de-binding the 3D-printed object comprises evaporation of the solvent and the surfactant at temperature of 100-200° C. for 0.2-2 h; and decomposition of the binder at temperature of 200-400° C. for 0.2-2 h, wherein the heating and cooling rates are 0.1-10° C./min.

In one embodiment, said heating the de-bonded 3D-printed object comprises heating the de-bonded 3D-printed object first at temperature of 750-950° C. for 5-15 h with a heating rate of 1-2° C./min, and then up to temperature of 1100° C. for 15-25 h with a heating rate of 10° C./min and a cooling rate of 1-2° C./min, so as to obtain the additively manufactured object.

In one embodiment, said performing the single-crystal growth utilizes a monocrystalline seed to grow the monocrystalline structures from the polycrystalline 3D-printed object via a melt growth process, which transforms the 3D-printed micro-lattices from polycrystal to monocrystal.

In one embodiment, the monocrystalline seed comprises a MgO substrate a REBCO thin film, and/or a REBa₂Cu₃O₇₋ₓ thin film.

In one embodiment, said performing the single-crystal growth comprises heating the polycrystalline 3D-printed object above its peritectic temperature to decompose the RE123 phase to the RE211+(Ba,Cu-rich) liquid phase; and cooling the RE211+(Ba,Cu-rich) liquid phase at a very slow rate (0.1-1 K/h) which, upon crossing the peritectic temperature, triggers single-crystal growth initiated from a REBa₂Cu₃O₇₋ₓ single-crystal thin film seed.

In one embodiment, the polycrystalline 3D-printed object is heated at temperature of 1050-1120° C. for 1 h with a heating rate of 100° C./h; cooled to temperature of 1015-1005° C. with a cooling rate of 50° C./h; cooled to temperature of 985-995° C. with a cooling rate of 0.1-1° C./h; held at 985-995° C. for 10 h; and cooled to room temperature with a cooling rate of 1-2° C./min, under dry air flow.

In one embodiment, geometric details of the 3D-printed object survive the melt growth process, without slumping, sagging or collapse.

In one embodiment, the 3D-printed object has an excellent shape fidelity to achieve a nearly hundred-fold improvement in the critical current density as compared to existing polycrystalline YBCO objects created by AM.

In another aspect, the invention relates to a monocrystalline superconductor, comprising monocrystalline structures grown from an additively manufactured object with desired architecture, wherein the additively manufactured object comprises a polycrystalline 3D-printed object comprising REBa₂Cu₃O₇₋ₓ(RE123)+RE₂BaCuO₅(RE211), wherein RE represents a rare-earth element selected from the group consisting of Y, La, Sm, Nd, Gd, and Eu.

In one embodiment, the additively manufactured object is formed by extruding an ink into micro-lattices layer by layer to form a three dimension (3D)-printed object with a desired architecture, wherein the ink comprises a mixture of powders of RE₂O₃, BaCO₃, and a Ba and/or Cu precursor with a binder and a solvent; and sintering the 3D-printed object to obtain a polycrystalline 3D-printed object comprising REBa₂Cu₃O₇₋ₓ (RE123)+RE₂BaCuO₅(RE211).

In one embodiment, the Ba- and/or Cu-precursor comprises CuO, BaO, Cu₂O, CuCO₃·Cu(OH)₂, Cu₂(OH)₃Cl, CuCl₂, CuNO₃, CuSO₄, or a combination thereof.

In one embodiment, the ink comprises a composition of RE123+(10-50) wt. % RE211+(0-5) wt. % (CeO₂ or Pt) formed by mixing powders of RE₂O₃, BaCO₃, the Ba and/or Cu precursor, and (CeO₂ or Pt) with the binder and the solvent.

In one embodiment, the additively manufactured object includes a horizontal coil, a toroidal coil, a hollow cylinder, an Origami object, a Kirigami object, a lattice band object, or a combination thereof.

In one embodiment, the monocrystalline structures are grown from the additively manufactured object by utilizing a monocrystalline seed to grow the monocrystalline structures from the polycrystalline 3D-printed object via a melt growth process, which transforms the 3D-printed micro-lattices from polycrystal to monocrystal.

In one embodiment, the desired architecture of the 3D-printed object survives the melt growth process, without slumping, sagging or collapse.

In one embodiment, the 3D-printed object has an excellent shape fidelity to achieve a nearly hundred-fold improvement in a critical current density as compared to existing polycrystalline YBCO objects created by AM.

In one embodiment, the superconductor has a critical current density J_{c} of about 2.1×10⁴ A/cm², and a critical temperature T_{c} of about 88-89.5 K.

These and other aspects of the present invention will become apparent from the following description of the preferred embodiment taken in conjunction with the following drawings, although variations and modifications therein may be affected without departing from the spirit and scope of the novel concepts of the invention.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1. (a) Schematic illustration of 3D-ink-extrusion printing, sintering, and top-seeded melt growth process of a toroidal Y123+Y211 coil. The inset photograph shows a toroidal coil during layer by layer printing from bottom to up, using a 250 μm diameter nozzle. (b) Plot of the relative mass of extruded ink as a function of temperature, as measured by TGA under O₂ flow, with two processes (debinding and Y123 synthesis) marked. (c) Stacked X-ray spectra acquired during in-situ diffraction of a blend of Y₂O₃—BaCO₃—CuO upon heating under oxygen from 500 to 850° C., demonstrating the synthesis of pure Y123. (d) X-ray diffraction spectrum of micro-lattice after sintering at 1000° C. for 20 h (e) Optical micrographs of the green and the sintered micro-lattice, illustrating uniform shrinkage. (f) SEM micrograph and Inverse Pole FIG. map of polished cross-sections of the sintered micro-lattice showing polycrystalline structure.

FIG. 2. (a) Photographs of a micro-lattice after 3D-ink-printing (green state), sintering, and single crystal growth for Y123+Y211. (b) SEM-BSE micrographs of cross-sections of the 3D-printed lattice after sintering and the top seeded melt growth, showing efficient removal of pores by the melt. Insert shows Y211 and BaCeO₃ particles in the Y123 matrix. (c) XRD spectra for the top and bottom faces of the 3D-printed lattice after single-crystal growth, showing single c-axis orientation on both faces. (d) Higher magnification IPF map (left) and phase map (right) showing distribution of the Y211 phase (green) in the Y123 phase (gray). (e) Stitched IPF maps of full vertical cross-section on the side face of the 3D-printed lattice, showing {100}/{010}orientation (single crystal), using a cubic version of Y123 for indexing. (f) Enlarged SEM-BSE micrographs showing the Y211 concentrated at convergence planes (circled), following the growth of the single crystal (marked with dotted lines).

FIG. 3. Superconducting properties of YBCO (polycrystalline Y123 and monocrystalline Y123+Y211) sintered ink-ingot specimens. (a) Temperature dependence of magnetic moment, as measured at 5 mT and in a zero-field cooling mode, with critical temperatures marked. (b) Temperature dependence of resistance for monocrystalline Y123+Y211, as measured under zero external magnetic field, with critical temperature marked. (c) Temperature dependence of AC susceptibility of the real and imaginary parts of the magnetic susceptibility (χ′ and χ″) for monocrystalline Y123+Y211, as measured under AC field amplitude of 0.01 mT at a frequency of 10 Hz. (d, e) Plots of magnetization vs. magnetic field at 10, 35, 55, and 77 K (the magnetic field (H) is parallel to the c-axis of the monocrystalline sample, H∥c). (f) Plot of critical current density vs. magnetic field at 10 and 77 K (with two orientations for the single crystal: H∥c and H∥ab).

FIG. 4. 3D-printed poly- and monocrystalline objects with complex architectures (a) Photographs for the 3D printed Y123+Y211 horizontal coil loop after printing (green), sintering, single-crystal growth (seed marked with “S”), substrate removal, and levitation at 77 K. The IPF and phase map on the side view and the IPF map on the top view are added next to the substrate-removed sample. After inducing a persistent field/current, the evolution of the generated magnetic field as a function of time is shown for up to 1000 seconds. (b) Photographs for the 3D printed, sintered, monocrystalline, and levitated tube. SEM-BSE micrograph on the seeded surface is shown. The magnetic field as measured inside the tube as a function of the applied outside magnetic field is shown. (c) Photographs for the 3D printed, sintered, monocrystalline (substrate removed), and levitated toroidal coil. SEM-BSE micrograph on the seeded surface is shown. SEM-BSE micrograph and IPF map on the cross-section show high densification, with individual ink-deposited strands, fused to each other. The printing path is illustrated. (d) Photographs for 3D printed green plate and schematic figure of green lattice band. The following photographs show a boat, a plane, and a lattice band after Origami folding, sintering (without subsequent single-crystal growth), and levitation.

FIG. 5. (a) Schematic illustration of the ball milling process. The powder blend was roller-mixed in a High-Density Polyethylene (HDPE) bottle with zirconia balls as mixing medias. After the initial 48 hours of ball milling, PLGA and EGBE are then added for an additional 12 hours of ball milling. (b) SEM-BSE micrograph for precursor powders: Y₂O₃ (0.5-1 μm), BaCO₃ (0.8 m), and CuO powder (25-55 nm). (c) Energy-Dispersive Spectroscopy (EDS) micrographs of powder blends, showing uniform distribution of Y, Ba, and Cu elements after ball milling at 2, 4, 24, and 48 h with a ball-to-powder weight ratio of 2:1. A 10 nm Y₂O₃ powder is used for these blend, which is replaced by 0.5-1 m Y₂O₃ powders for all other samples to prevent accidental loss by electrostatic separation during handling. Powders can be de-agglomerated and mixed homogeneously after ball milling of 48 h. The ball-to-powder weight ratio is increased to 5:1 with a mixing time of 48 h for all other samples for better mixing.

FIG. 6. (a) Photographs of a 3D printed micro-lattice before and after polystyrene debinding at 450° C. for 30 min under four atmospheres (pure O₂, air, Ar-1 mol. % O₂, and pure Ar). Cracks (arrows) are formed when the sample debinds under pure O₂, air, and Ar-1% O₂. The red color of the micro-lattice after Ar debinding indicates reduction of CuO by carbon-rich decomposition products of polystyrene. Coarsening of nano-Cu particles is expected to happen after reduction. (b) TGA and DSC plots of ink subjected to PLGA debinding, upon heating from 50 to 400° C. under pure O₂, air, and Ar-1% O₂ (50 ml/min). The exothermic heat signal decreases as the oxygen content in the gas decreases, indicating a reduction in combustion of binder (or their decomposition products) at a low oxygen partial atmosphere. (c) Top: photographs of 3D printed lattice before and after PLGA debinding (300° C./30 min) under pure O₂ followed by sintering at 880° C. for 10 h under O₂; some cracks are marked with arrows. Bottom: photographs of 3D printed micro-lattice before and after PLGA debinding (300° C./30 min) under Ar-1% O₂ and sintering at 1000° C. for 20 h under O₂; no cracks are found when PLGA is debinded s Ar-1% O₂.

FIG. 7. SEM-BSE micrographs of the cross-section of 3D printed micro-lattice samples after debinding at 450° C. for 30 min, sintering at 985° C. for 20 h, and sintering at 1000° C. for 20 h under pure O₂. The binder used is polystyrene. The SEM figures are taken in crack-free regions. The sample with polystyrene as binder shows a similar microstructure shown in FIG. 1 (f) at 1000° C. for 20 h.

FIG. 8. (a) SEM-BSE micrograph of the Y211 particles, imaged on the liquid-depleted surface (green color region) of 3D printed micro-lattice sample after single crystal growth. (b) The distribution for the aspect ratios of Y211 particles measured from (a). The Y211 particles whose main axis is close to being in-plane are selected for measurements. (c) The vertical section of Y₂O₃—BaO—CuO phase diagram in air. The liquidus line is from experimental data. The percolation thresholds for Y211 particles (green line) and liquid phase (gray line) are shown. The maximum temperature (˜1120° C.) that NdBCO seeds can be used is shown as orange line. The composition of current research is shown as a red dot and corresponds to 51 mol. % (or 36 vol. %) of solid Y211 particles. Here, the molar volume of the liquid phase is assumed to be the same as that of 3BaCuO₂+2CuO (“Ba₃Cu₅O₈”) for calculating mole fraction from volume fraction.

FIG. 9. A photograph of a horizontal coil sample with a clearly visible fan-shaped growth surface, showing four distinct growth sectors after single crystal growth. A mesh-like surface was used to reduce friction between the sample and the substrate during sintering. The square surface of seed (labeled as “S”) has a dimension of 2×2 mm².

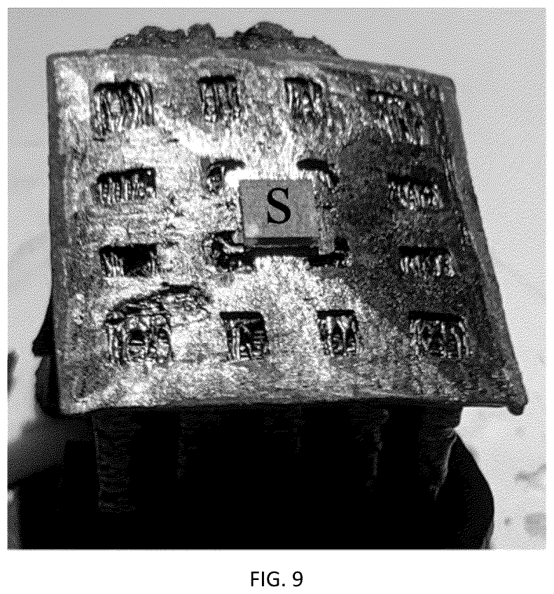

FIG. 10. Pole figures for polycrystal microstructures shown in FIG. 6, (c), and single-crystal microstructures shown in FIG. 1, (e), in FIG. 2, (a)—top view of the sample, and in FIG. 2, (c).

FIG. 11. Schematic figure showing an ink ingot after sintering and single-crystal growth. The locations and dimensions of the two samples used for magnetization (2.2×1.1×1.8 mm³) and resistance measurements (half cylinder, a radius of 3.1 mm and a thickness of 1.1 mm) are labeled.

FIG. 12. (a) Plot of magnetization vs. magnetic field for single-crystal samples when the magnetic field is parallel to the a/b axis of Y123. (b, c) Critical current density as a function of magnetic field for poly- and monocrystalline (H∥c and H∥ab) YBCO at (b) 35 K and (c) 55 K.

FIG. 13. Photographs of setup to test the (a) coil loop and (b) hollow tube (height: 18.1 mm, mean outer radius: 8.6 mm, wall thickness: 0.6 mm, and mean inner radius: 8.0 mm). (c) The evolution of the generated magnetic field of the coil loop as a function of time was extended up to 10,000 seconds. The additional noise beyond 1000 sec is due to small shifts of the probe from adding LN₂.

### DETAILED DESCRIPTION OF THE INVENTION

The invention will now be described more fully hereinafter with reference to the accompanying drawings, in which exemplary embodiments of the invention are shown. However, this invention may be embodied in many different forms and should not be construed as limited to the embodiments set forth herein. Rather, these embodiments are provided so that this specification will be thorough and complete and fully convey the invention's scope to those skilled in the art. Like reference numerals refer to like elements throughout.

The terms used in this specification generally have their ordinary meanings in the art, within the context of the invention, and in the specific context where each term is used. Certain terms used to describe the invention are discussed below, or elsewhere in the specification, to provide additional guidance to the practitioner regarding the description. For convenience, certain terms may be highlighted, for example using italics and/or quotation marks. The use of highlighting has no influence on the scope and meaning of a term; the scope and meaning of a term are the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that, as used in the description herein and throughout the claims that follow, the meaning of “a”, “an”, and “the” includes plural reference unless the context clearly dictates otherwise. Also, it will be understood that when an element is referred to as being “on” another element, it can be directly on the other element or intervening elements may be present therebetween. In contrast, when an element is referred to as being “directly on” another element, there are no intervening elements present. As used herein, the term “and/of” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, or section without departing from the invention's teachings.

Furthermore, relative terms, such as “lower” or “bottom” and “upper” or “top,” may be used herein to describe one element's relationship to another element as illustrated in the figures. It will be understood that relative terms are intended to encompass different orientations of the device in addition to the orientation depicted in the figures. For example, if the device in one of the figures. is turned over, elements described as being on the “lower” side of other elements would then be oriented on “upper” sides of the other elements. The exemplary term “lower”, can, therefore, encompasses both an orientation of “lower” and “upper,” depending on the particular orientation of the figure. Similarly, if the device in one of the figures is turned over, elements described as “below” or “beneath” other elements would then be oriented “above” the other elements. Therefore, the exemplary terms “below” or “beneath” can encompass both an orientation of above and below.

It will be further understood that the terms “comprises” and/or “comprising,” or “includes” and/or “including” or “has” and/or “having”, or “carry” and/or “carrying,” or “contain” and/or “containing,” or “involve” and/or “involving, and the like are to be open-ended, i.e., to mean including but not limited to. When used in this specification, they specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification, and will not be interpreted in an idealized or overly formal sense unless expressly so defined herein.

As used in this specification, “around”, “about”, “approximately” or “substantially” shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated.

As used in this specification, the phrase “at least one of A, B, and C” should be construed to mean a logical (A or B or C), using a non-exclusive logical OR. As used herein, the term “and/or” includes any and all combinations of one or more of the associated listed items.

The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in a different order (or concurrently) without altering the principles of the invention.

Rare-earth (RE) Barium Copper Oxide (REBCO) is the high-temperature cuprate oxide with a superconducting critical temperature (T_{c}˜90 K), enabling various transformational applications, both for existing (e.g., magnetic resonance imaging, nuclear magnetic resonance) and future (e.g., fusion power plants, maglev trains). However, grain boundaries are weak links for current transport in REBCO. Therefore, REBCO superconductors are mainly used as coated tapes/wires or single-crystal bulks. These ceramic-like tapes and single-crystal bulks cannot achieve complex three dimensional (3D)-objects easily.

3D-ink-printing, an additive manufacturing (AM) method, extrudes a powder-loaded ink, layer by layer, and the resulting green part is then sintered to achieve densification. The isothermal sintering and subsequent slow cooling prevent the formation of thermal-shock induced cracks in ceramics, which are frequently observed in laser-beam-based AM methods. Also, ink can utilize submicron and nanoparticles of various shapes and size distribution, unlike powder-bed-based AM methods (binder/ink jet printing) for which powder flowability is limiting. To date, only polycrystalline Y123 superconductors have been fabricated by 3D ink-printing. These polycrystalline microstructures are unable to create/trap a strong magnetic field or achieve heavy-load levitation.

One of the objectives of this invention is to develop a novel approach, where a single crystal is grown from a 3D-ink-printed RE123+RE211 architectures (with or without additional Origami folding) with an excellent shape fidelity, achieving a nearly hundred-fold improvement in critical current density as compared to prior polycrystalline Y123 objects created by AM, where the letters “RE” represents a rare-earth element selected from the group consisting of yttrium (Y), lanthanum (La), samarium (Sm), neodymium (Nd), gadolinium (Gd) and europium (Eu).

Specifically, the invention discloses that 3D-ink-printing can fabricate cuprate superconductors with complex 3D architectures. A powder-loaded ink is extruded layer by layer to form the green part, which is then sintered in pure oxygen to achieve densification. Ink can contain submicron and nanoparticles of various shapes and size distribution. The isothermal sintering and subsequent slow cooling prevent the formation of thermal-shock-induced cracks, which are always found in laser-beam-based AM methods. To date, additively manufactured YBCO superconductors have polycrystalline microstructure with low critical current density. For the first time, we demonstrate a route to obtain a single crystal from additively manufactured, polycrystalline, sintered superconducting RE123+RE₂BaCuO₅(RE211), with both high critical current density and high critical temperature. An ink loaded with RE₂O₃(Primarily: Y₂O₃, alternatively: La₂O₃, Sm₂O₃, Nd₂O₃, Gd₂O₃, or Eu₂O₃), BaCO₃, and CuO (or other Ba- and Cu-precursors, such as BaO, Cu₂O, CuCO₃·Cu(OH)₂, Cu₂(OH)₃Cl, CuCl₂, CuNO₃, CuSO₄) powders is 3D-extruded into micro-lattices, followed by reaction-sintering to obtain polycrystalline RE123+RE211. Then, a single-crystal seed is used to achieve single-crystal microstructure in the whole 3D-printed micro-lattices by the melt growth method. Though a liquid phase appears above the peritectic temperature, the 3D-printed micro-lattices maintain their shapes and geometric details without slumping, sagging, or collapsing. Complex-shaped monocrystalline REBCO objects, including horizontal and toroidal coils, are successfully additively manufactured and made monocrystalline by this method. Furthermore, folding can be performed after 3D printing to obtain Origami structures. It should be noted that an Origami structure is a 3D structure with folded shapes of sheets and/or plates. The folding pattern and geometry of the structure determine its mechanical properties. Origami structures have been used in engineering to create load-bearing structures, robots, and other devices. This method is applicable to additive manufacturing of other monocrystalline cuprate superconductors.

The invention, among other things, has the advantages with efficiently fabricated superconducting objects (poly- or mono-crytalline) with simple or complex geometries and architectures, as compared with traditional cold pressing and thin film deposition. Single-crystal microstructures avoid the formation of grain boundary and thus 3D printed objects have a much higher critical current density. Origami folded shapes can be implemented after 3D printing of sheets, to achieve 3D shapes that are difficult to fabricate. Kirigami structures can also be implemented.

This invention can efficiently fabricate complex REBCO 3D components with very high superconducting performance due to their monocrystalline structure. This can be potentially used for many complex-shape devices, such as magnetic resonance imaging, nuclear magnetic resonance, fusion power plants, maglev trains, and accelerators. It paves the way for 3D-ink-printing of other monocrystalline cuprate superconductors. This approach is also relevant to additive manufacturing of other (beyond superconductivity) monocrystalline functional ceramic or semiconductor materials, e.g., piezoelectrics, thermoelectrics, photovoltaics, and organic semiconductors.

The invention may also have applications in superconducting magnetic bearings, energy storage applications, quantum applications, dark matter experiments (microwave cavities), undulator with short periods for accelerator construction, superconducting magnetic shielding device, superconducting motors and generators, components for fusion power plants, components for maglev trains, and the like.

Without intent to limit the scope of the invention, exemplary embodiments of the invention are given below.

In one embodiment, the method for fabricating a monocrystalline superconductor, comprises providing an ink comprising a mixture of powders of RE₂O₃, BaCO₃, and a Ba and/or Cu precursor with a binder and a solvent; extruding the ink into micro-lattices layer by layer to form a three dimension (3D)-printed object with a desired architecture; sintering the 3D-printed object to obtain a polycrystalline 3D-printed object comprising REBa₂Cu₃O₇₋ₓ(RE123)+RE₂BaCuO₅(RE211); and performing single-crystal growth of monocrystalline structures from the polycrystalline 3D-printed object to fabricate the monocrystalline superconductor, wherein RE represents a rare-earth element selected from the group consisting of Y, La, Sm, Nd, Gd, and Eu.

In one embodiment, the Ba- and/or Cu-precursor comprises CuO, BaO, Cu₂O, CuCO₃·Cu(OH)₂, Cu₂(OH)₃Cl, CuCl₂, CuNO₃, CuSO₄, or a combination thereof.

In one embodiment, the ink comprises a composition of RE123+(10-50) wt. % RE211+(0-5) wt. % (CeO₂ or Pt) formed by mixing powders of RE₂O₃, BaCO₃, the Ba and/or Cu precursor, and (CeO₂ or Pt) with the binder and the solvent.

In one embodiment, the ink composition comprises 69 wt. % REBa₂Cu₃O₇₋ₓ+30 wt. % RE₂BaCuO₅+1 wt. % CeO₂.

In one embodiment, the method further comprises performing rapid evaporation of the solvent after said extruding the ink to prevent slumping and sagging of printed filaments in the 3D-printed object.

In one embodiment, the binder comprises poly-lactic-co-glycolic-acid (PLGA), or polystyrene (PS), or polyethylene oxide (PEO), and the solvent comprises dichloromethane (DCM).

In one embodiment, the ink further comprises a plasticizer and/or a surfactant.

In one embodiment, the plasticizer comprises dibutyl phthalate (DBP), and the surfactant comprises ethylene glycol butyl ether (EGBE).

In one embodiment, said sintering the 3D-printed object comprises de-binding the 3D-printed object at temperature in a range of 100-400° C. under flowing Ar-1 mol. % O₂; and heating the de-bonded 3D-printed object at temperature in a range of 750-1100° C. under flowing O₂.

In one embodiment, said de-binding the 3D-printed object comprises evaporation of the solvent and the surfactant at temperature of 100-200° C. for 0.2-2 h; and decomposition of the binder at temperature of 200-400° C. for 0.2-2 h, wherein the heating and cooling rates are 0.1-10° C./min.

In one embodiment, said heating the de-bonded 3D-printed object comprises heating the de-bonded 3D-printed object first at temperature of 750-950° C. for 5-15 h with a heating rate of 1-2° C./min, and then up to temperature of 1100° C. for 15-25 h with a heating rate of 10° C./min and a cooling rate of 1-2° C./min, so as to obtain the additively manufactured object.

In one embodiment, said performing the single-crystal growth utilizes a monocrystalline seed to grow the monocrystalline structures from the polycrystalline 3D-printed object via a melt growth process, which transforms the 3D-printed micro-lattices from polycrystal to monocrystal.

In one embodiment, the monocrystalline seed comprises a MgO substrate a REBCO thin film, and/or a REBa₂Cu₃O₇₋ₓ thin film.

In one embodiment, said performing the single-crystal growth comprises heating the polycrystalline 3D-printed object above its peritectic temperature to decompose the RE123 phase to the RE211+(Ba,Cu-rich) liquid phase; and cooling the RE211+(Ba,Cu-rich) liquid phase at a very slow rate (0.1-1 K/h) which, upon crossing the peritectic temperature, triggers single-crystal growth initiated from a REBa₂Cu₃O₇₋ₓ single-crystal thin film seed.

In one embodiment, the polycrystalline 3D-printed object is heated at temperature of 1050-1120° C. for 1 h with a heating rate of 100° C./h; cooled to temperature of 1015-1005° C. with a cooling rate of 50° C./h; cooled to temperature of 985-995° C. with a cooling rate of 0.1-1° C./h; held at 985-995° C. for 10 h; and cooled to room temperature with a cooling rate of 1-2° C./min, under dry air flow.

In one embodiment, geometric details of the 3D-printed object survive the melt growth process, without slumping, sagging or collapse.

In one embodiment, the 3D-printed object has an excellent shape fidelity to achieve a nearly hundred-fold improvement in the critical current density as compared to existing polycrystalline YBCO objects created by AM.

In one embodiment, the monocrystalline superconductor comprises monocrystalline structures grown from an additively manufactured object with desired architecture, wherein the additively manufactured object comprises a polycrystalline 3D-printed object comprising REBa₂Cu₃O₇₋ₓ(RE123)+RE₂BaCuO₅(RE211), wherein RE represents a rare-earth element selected from the group consisting of Y, La, Sm, Nd, Gd, and Eu.

In one embodiment, the additively manufactured object is formed by extruding an ink into micro-lattices layer by layer to form a three dimension (3D)-printed object with a desired architecture, wherein the ink comprises a mixture of powders of RE₂O₃, BaCO₃, and a Ba and/or Cu precursor with a binder and a solvent; and sintering the 3D-printed object to obtain a polycrystalline 3D-printed object comprising REBa₂Cu₃O₇₋ₓ (RE123)+RE₂BaCuO₅(RE211).

In one embodiment, the Ba- and/or Cu-precursor comprises CuO, BaO, Cu₂O, CuCO₃·Cu(OH)₂, Cu₂(OH)₃Cl, CuCl₂, CuNO₃, CuSO₄, or a combination thereof.

In one embodiment, the ink comprises a composition of RE123+(10-50) wt. % RE211+(0-5) wt. % (CeO₂ or Pt) formed by mixing powders of RE₂O₃, BaCO₃, the Ba and/or Cu precursor, and (CeO₂ or Pt) with the binder and the solvent.

In one embodiment, the monocrystalline structures are grown from the additively manufactured object by utilizing a monocrystalline seed to grow the monocrystalline structures from the polycrystalline 3D-printed object via a melt growth process, which transforms the 3D-printed micro-lattices from polycrystal to monocrystal.

In one embodiment, the desired architecture of the 3D-printed object survives the melt growth process, without slumping, sagging or collapse.

In one embodiment, the 3D-printed object has an excellent shape fidelity to achieve a nearly hundred-fold improvement in a critical current density as compared to existing polycrystalline YBCO objects created by AM.

In one embodiment, the superconductor has a critical current density J_{c} of about 2.1×10⁴ A/cm², and a critical temperature T_{c} of about 88-89.5 K.

In one embodiment, the additively manufactured object includes a horizontal coil, a toroidal coil, a hollow cylinder, an Origami object, a Kirigami object, a lattice band object, or a combination thereof.

In one embodiment, the horizontal coil is designed with a height of 11 mm, a single contour layer, a layer height of 200 μm, and a horizontal spacing of 350 μm.

In one embodiment, the toroidal coil is designed with a bending radius of 2.5 mm, a wire diameter of 1.4 mm, and a total turn of 20.

In one embodiment, the hollow cylinder has a height of 30 mm, a diameter of 14 mm, and two contour layers.

In one embodiment, the Origami object includes a boat or a plane, folded manually from plates with a thickness of two layers and a horizontal spacing of 0.35 mm.

In one embodiment, the lattice band object is bent manually from lattice plates with a thickness of two layers and a horizontal spacing of 650 μm.

These and other aspects of the invention are further described below. Without intent to limit the scope of the invention, exemplary instruments, apparatus, methods, and their related results according to the embodiments of the invention are given below. Note that titles or subtitles may be used in the examples for convenience of a reader, which in no way should limit the scope of the invention. Moreover, certain theories are proposed and disclosed herein; however, in no way they, whether they are right or wrong, should limit the scope of the invention so long as the invention is practiced according to the invention without regard for any particular theory or scheme of action.

### EXAMPLE

### Additively Manufactured Monocrystalline YBCO Superconductor

Single-crystal microstructures bring high performance to yttrium barium copper oxide (YBa₂Cu₃O₇₋ₓ) superconductor which are however limited to simple shapes (e.g., thin films or pellets) due to their brittleness. Additive manufacturing—in particular 3D-ink-printing—can fabricate YBa₂Cu₃O₇₋ₓ superconductor with complex shapes, albeit with a polycrystalline microstructure.

In this example, we demonstrate a route to grow single-crystals from 3D-ink-printed, polycrystalline, sintered superconducting YBa₂Cu₃O₇₋ₓ(YBCO or Y123)+Y₂BaCuO₅ (Y211), manufacturing objects with complex architectures displaying both high critical current density (J_{c}=2.1×10⁴ A·cm⁻², 77 K) and high critical temperature (T_{c}=88 K). An ink containing precursor powders (Y₂O₃, BaCO₃, and CuO) is 3D-extruded into micro-lattices and then reaction-sintered to obtain polycrystalline Y123+Y211. A seed is then utilized to transform these 3D-printed micro-lattices from polycrystal to monocrystal via the melt growth method. The geometric details of 3D printed micro-lattices survive the process, without slumping, sagging or collapse, despite the long-term presence of liquid above the peritectic temperature. More complex monocrystalline Y123+Y211 items—such as horizontal and toroidal coils—are successfully fabricated, as well as Origami structures where sheet folding is performed after 3D printing. This additive approach enables the facile fabrication of superconducting devices with complex shapes and architectures, such as advanced undulator magnets to generate synchrotron radiation and microwave cavities for dark matter axion search. It paves the way for future studies on 3D-ink-printing of other monocrystalline cuprate superconductors. This also sheds light on the studies of additive manufacturing of other monocrystalline functional ceramic or semiconductor materials.

### Experimental Methods

### Ink Preparation and 3D Printing:

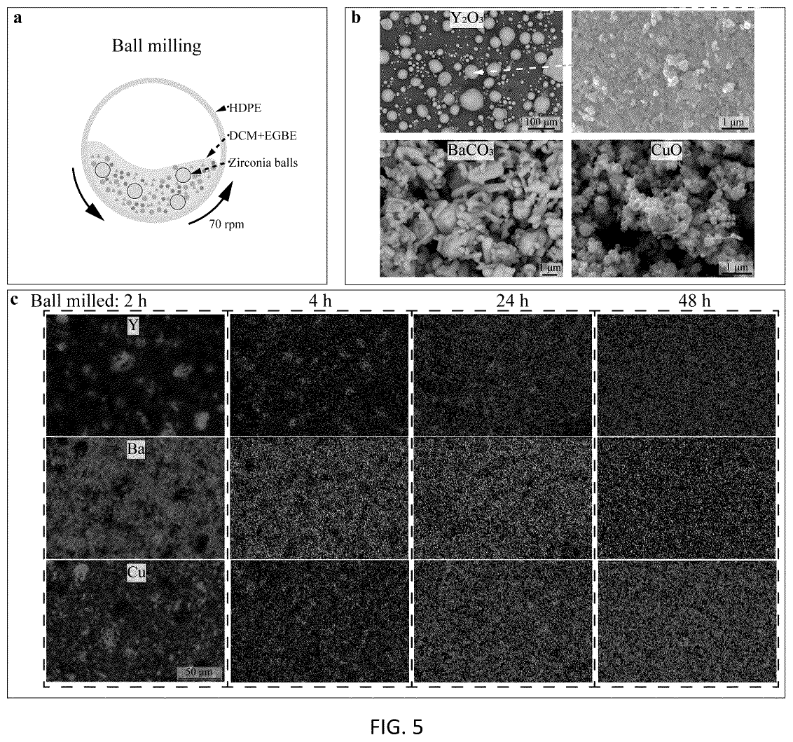

Inks with a composition of 69 wt. % Y123+30 wt. % Y211+1 wt. % CeO₂ are made by mixing Y₂O₃(1.17 g, purity: 99.995%, powder size: 0.5-1 μm, supplier: SkySpring Nanomaterials, Inc.), BaCO₃ (2.37 g, 99.8%, 0.8 μm, US Research Nanomaterials, Inc.), CuO (1.32 g, >99.95%, 25-55 nm, US Research Nanomaterials, Inc.), CeO₂ (0.04 g, 99.97%, 10-30 nm, US Research Nanomaterials, Inc.) powders, with addition of (i) binder: poly-lactic-co-glycolic-acid (0.5 g, PLGA, Evonik Industries), (ii) solvent: dichloromethane (10 ml, DCM, Sigma-Aldrich), (iii) plasticizer: dibutyl phthalate (0.91 g, DBP, Sigma-Aldrich), and (iv) surfactant: ethylene glycol butyl ether (0.45 g, EGBE, Sigma-Aldrich). The composition for pure Y123 inks uses 0.75 g Y₂O₃, 2.58 g BaCO₃, and 1.56 g CeO₂. Roller milling (70 rpm) with zirconia balls (ball to powder ratio: 5:1) is carried out in high-density polyethylene (120 ml) bottle for 48 h to mix powders with DCM and EGBE (FIG. 5). Then, PLGA and EGBE are added for another 12 h ball milling. The excess DCM in the ink is evaporated at ˜40° C. to adjust the viscosity with a final powder loading of ˜37% (the rheological properties of the PLGA-DBP-DCM ink system have been studied in detail in Reference [14]).

3D-ink-printing is carried out with a 3D-Bioplotter (EnvisionTEC, Germany) with conical 250 μm plastic nozzles (Nordson EFD). The 10×10×5 mm³ lattices are printed with a layer height of 200 μm, a horizontal spacing of 500 μm, and a layer rotation angle of 90°. The horizontal coil is designed based on Thingiverse.com (thing: 1493458) and has a height of 11 mm, a single contour layer, a layer height of 200 μm, and a horizontal spacing of 350 μm. The toroidal coil is designed with a bending radius of 2.5 mm, a wire diameter of 1.4 mm, and a total turn of 20. The hollow cylinder has a height of 30 mm, a diameter of 14 mm, and two contour layers. The Origami samples, including boat and plane, are folded manually from plates with a thickness of two layers and a horizontal spacing of 0.35 mm. The lattice band sample is bent manually from lattice plates with a thickness of two layers and a horizontal spacing of 650 μm. Lastly, a uniform ink ingot is made by extruding ink (with a decreased level of DCM evaporation) into a cylinder mold followed by drying, which is used for measuring superconducting properties.

### Sintering and Growing Single Crystals:

The printed samples are firstly heated under flowing 1 mol. % O₂/Ar for de-binding. Two steps are included in the de-binding: (i) evaporation of residual DCM solvent and EGBE at 150° C. for 30 min, and (ii) decomposition of PLGA binder polymer at 300° C. for 30 min. The heating and cooling rates are 2° C./min. Then, the solid-state synthesis and sintering are performed in two steps under flowing O₂ (99.999% pure). First, the sample was heated at 880° C. for 10 h with a heating rate of 1° C./min. Second, the samples were heated up to 1000° C. for 20 h with a heating rate of 10° C./min and a cooling rate of 1° C./min.

After sintering, the top seed melt growth is performed to transform 3D-printed polycrystal samples into single-crystal samples. The monocrystalline seed (from Ceraco ceramic coating GmbH) is a 2×2 mm² MgO substrate, with a 20 nm YBCO thin film and a 500 nm NdBa₂Cu₃O₇₋ₓ(NdBCO) thin film. The sintered samples are heated at 1090° C. for 1 h with a heating rate of 100° C./h, cooled to 1008° C. with a cooling rate of 50° C./h, cooled to 991° C. with a cooling rate of 0.5° C./h, held at 991° C. for 10 h, and cooled to room temperature with a cooling rate of 1° C./min. The atmosphere is under dry air flow. The flipped toroidal coil sample was supported by a sintered Y123+Y211 tube (diameter: 5.4 mm, height: 3.8 mm) in its center. Samples with the substrate are then fully mounted in Crystalbond 509 (AREMCO) followed by careful grinding on SiC grinding papers. After removing the substrate, the acetone is used to dissolve the Crystalbond. Long-term annealing at 450° C. for 150 h under pure oxygen (200 sccm) is followed for higher oxygen content in Y123.

### Characterization:

Thermogravimetric analysis (TGA) is carried out on Mettler Toledo TGA/DSC 3+. The extruded ink is placed in alumina crucibles. The TGA is then performed up to 1000° C. with a heating rate of 2° C./min under oxygen flow (50 ml/min).

In situ X-ray diffraction is performed on STADI MP. The measurement is performed with an Ag source on the Y₂O₃—BaCO₃—CuO powder blend (target composition: YBa₂Cu₃O₇₋ₓ) lodged in an externally heated quartz capillary (0.5 mm ID). Diffraction spectra are detected at each 5° C. step with 18.54° 2θ coverage and 300 s exposure. The heating rate is 5° C./min. The ex-situ X-ray diffraction is performed on the cross-sections of sintered samples on a Smartlab 3 kW Gen2.

Optical micrographs of samples are taken by a stereo microscope. Metallographic characterization is done on polished cross-sections of 3D-printed samples. Samples are cold mounted in epoxy resin, ground with SiC grinding papers with ethanol, polished with ethanol-based diamond suspensions (3 and 1 μm) and colloidal silica (0.05 μm), and coated with 4-8 nm Os. Scanning electron microscopy (SEM) and Electron Backscatter Diffraction (EBSD) are performed on a Quanta 650 instrument with an Oxford Symmetry 2 detector.

Superconducting properties including magnetization and resistivity are measured on a PPMS (Physical Properties Measurement System, Quantum Design) with a Vibrating Sample Magnetometer. The magnetization measurement is performed between 5 K and 150 K under a magnetic field of 5 mT. The resistance measurement is performed between 60 and 120 K at a heating rate of 0.5 K min⁻¹ with an applied current of 200 μA under zero external magnetic field. Four probes are attached to the ground surface of the sample by silver paste. The resistance test was conducted with the current flowing along the a/b-axis of sample. The resistivity is not provided here because the half-cylinder shape of the tested sample (with a diameter of 3.1 mm and a thickness of 1.1 mm) does not allow for a consistent cross-sectional area needed for calculation. The AC susceptibility measurement is performed using an MPMS3 (Magnetic Properties Measurement System, Quantum Design) in the temperature range of 30-100 K under zero-field cooling conditions. The measurement is conducted with an AC field amplitude of 0.01 mT applied along the c-axis of the single-crystal sample, zero DC field, and a frequency of 10 Hz. Magnetic hysteresis experiments are performed at 10, 35, 55, and 77 K under a magnetic field between −7 and 7 T. The critical current density J_{c} (A·cm⁻²) is calculated by Bean model:

$${J}_{c} = \frac{20 Δ M}{b ( 1 - \frac{b}{3 a} )}$$

where the ΔM (emu cm⁻³) is the width of the hysteresis loop at a specific magnetic field, and a and b (cm) are the dimensions of the cross-section (a>b) perpendicular to the applied field.

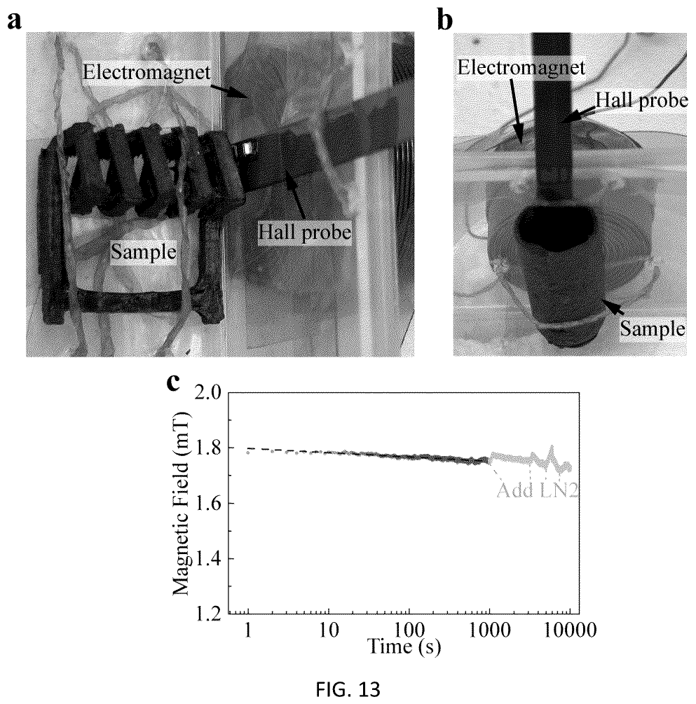

For the levitation, the sample is cooled in liquid nitrogen and then taken out to place on four Nd—Fe—B magnets (19×19×6 mm³, surface field: 0.3 T, K&J Magnetics, Inc.). For the persistent current of the coil loop, an electromagnet with a magnetic field of 40 mT is placed along the axis of the coil (FIG. 13, (a)). The external magnetic field is switched off after the sample is cooled down by a liquid nitrogen bath. A hall probe (EGHKCMS006, PARAGRAF) is used to measure the magnetic field generated by persistent current as a function of time, where each data point is an averaged value from 1000 times of measurements for 1 second. For the magnetic shielding of the cylinder, the cylinder sample with a hall probe inside it is immersed in a liquid nitrogen bath, where an external magnetic field is ramped up step by step (about 1 mT/10 s) by an electromagnet next to the sample (FIG. 13, (b)).

### Results and Discussion

### Sintering:

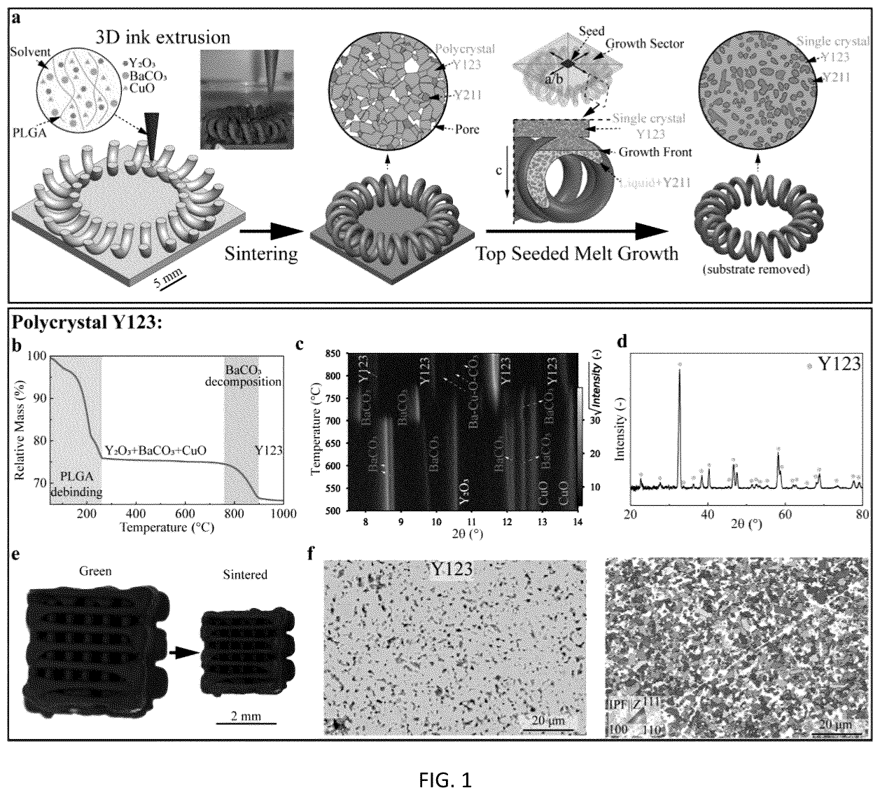

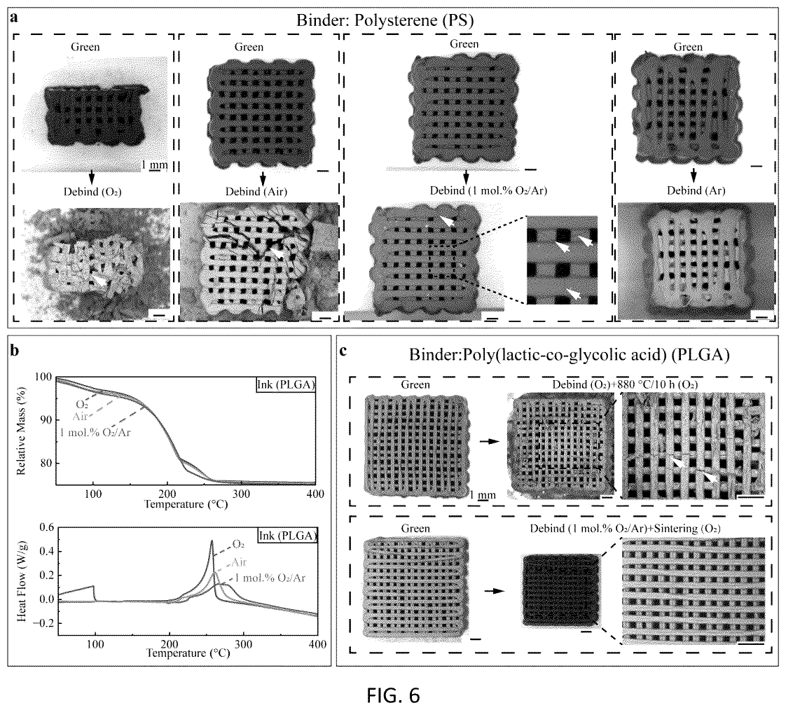

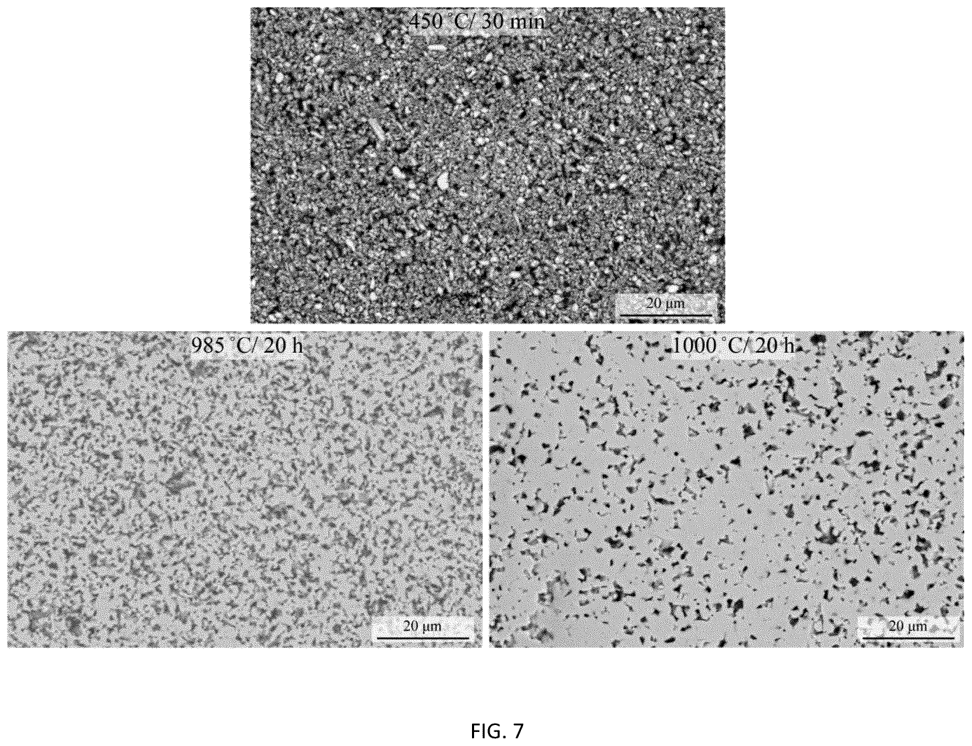

A powder-loaded ink—containing a blend of submicron Y₂O₃+BaCO₃+CuO precursor powders (FIG. 5) with a binder (PLGA), solvent (DCM), plasticizer (DBP), and surfactant (EGBE)—is extruded layer by layer from a 250 mm diameter nozzle to fabricate complex parts such as a toroidal coil, as shown in FIG. 1, (a). The rapid solvent evaporation after ink extrusion causes the binder to precipitate immediately after extrusion thereby increasing the strength of the deposited material, unlike non-evaporating ink systems. As a result, this ink system does not show slumping and sagging of the printed filaments and thus enables them to partially overhang and form the arcs in the toroidal coil without auxiliary supports. After printing, a relatively dense microstructure is needed to keep the integrity of the printed structure during the subsequent single-crystal growth step. Also, high densities minimize porosity near the growth front of the single crystal, enabling fast single-crystal growth. However, the powder-loaded ink includes loosely packed powders, making densification challenging. The composition targeted—pure YBa₂Cu₃O₇₋ₓ(Y123)—is first used to study the synthesis and sintering behavior. As shown in FIG. 1, (b), the relative mass of the extruded ink decreases between 5° and 350° C., which corresponds to the decomposition of the PLGA binder. The atmosphere for debinding is selected as Ar-1 mol. % O₂ to prevent cracking caused by binder combustion (FIG. 6). After debinding, another mass loss occurs between 75° and 900° C., corresponding to the decomposition of BaCO₃ releasing CO₂. From the in-situ X-ray diffraction data (FIG. 1, (c)), the BaCO₃ transforms from the orthorhombic to the trigonal phases at about 700° C. Thereafter, the tetragonal Y123 phase starts to form, while the decomposition of BaCO₃ continues. The diffraction peaks for BaCO₃ disappear at about 780° C., and the peaks of Ba_{1-y}CuO_{2+δ}·(CO₂)ₓ (Ba—Cu—O—CO₂) appear subsequently, consistent with the TGA results showing that CO₂ release is not complete until a temperature of 900° C. is reached. After full CO₂ release, the barium copper oxycarbonate is expected to transform to BaCuO₂, which forms a transient liquid phase above ˜970° C., thus facilitating the densification process. Therefore, a sintering temperature of 1000° C. is selected after comparing with an experiment carried out at 985° C. (FIG. 7). After sintering at 1000° C. for 20 h, the micro-lattice sample exhibits an orthorhombic Y123 phase (FIG. 1, (d)). The micro-lattices, before and after sintering (FIG. 1, (e)), show a uniform linear shrinkage of 34.7±0.3% without cracks or warpage. The densified polycrystal microstructures—with a relative density of 89±5% and a grain size of 1.4±0.6 μm—are shown in FIG. 1, (f).

### Single-Crystal Growth:

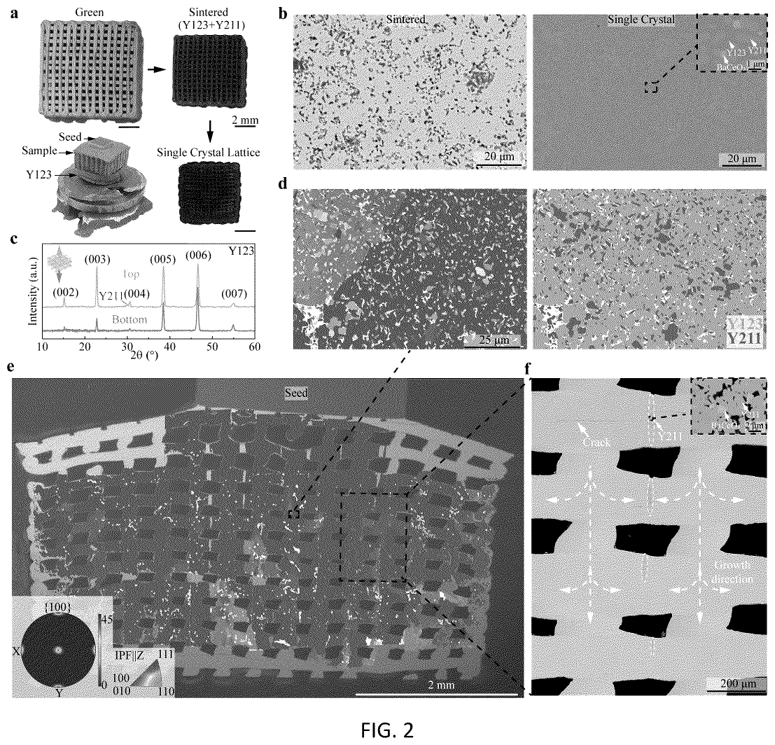

For single-crystal growth, the ink composition is altered to achieve a Y-rich, two-phase composition (69 wt. % YBa₂Cu₃O₇₋ₓ(superconducting Y123)+30 wt. % Y₂BaCuO₅ (non-superconducting Y211)+1 wt. % CeO₂, labeled as Y123+Y211) where (i) the Y211 phase provides additional Y to the Y-depleted melt near the growth front and (ii) CeO₂ helps refine the Y211 particles by reacting with Y211 to form Y₂O₃, BaCeO₃, and CuO. The newly formed Y₂O₃ particles can act as nucleation sites for Y211, ultimately leading to the formation of smaller, finely sized Y211 particles, providing more pinning centers for a higher critical current density J_{c}. It was demonstrated by Kim et al. that adding 1 wt. % CeO₂ to Y123-Y211 can double the critical current density from 1.1 to 2.0×10⁴ A/cm² at 77 K under a magnetic field of 1 T. After sintering at 1000° C./20 h, the sample shows a densified microstructure with a relative density of 78±1% and a linear shrinkage of 28.3±0.4% (FIG. 2, (a)-(b)). The sintered micro-lattice is then heated above its peritectic temperature to decompose the Y123 phase to the Y211+(Ba,Cu-rich) liquid phase. Cooling is performed at a very slow rate (0.5 K/h) which, upon crossing the peritectic temperature, triggers single-crystal growth initiated from a NdBa₂Cu₃O₇₋ₓ(NdBCO) single-crystal thin film seed. The formation of a liquid phase during the singe-crystal growth is expected to remove the residual pores by filling the pores and rearranging Y211 particles. A nearly fully densified microstructure is indeed observed (FIG. 2, (b)), including a Y123 matrix in which Y211 and BaCeO₃ particles are embedded. Despite liquid formation during the singe-crystal growth, the two printed micro-lattices kept their overall shape and printed details with high fidelity. A small extent of warpage is observed, but it is limited to the 2-3 printed layers (about 400 μm) that are close to the seed (FIG. 2, (e)).

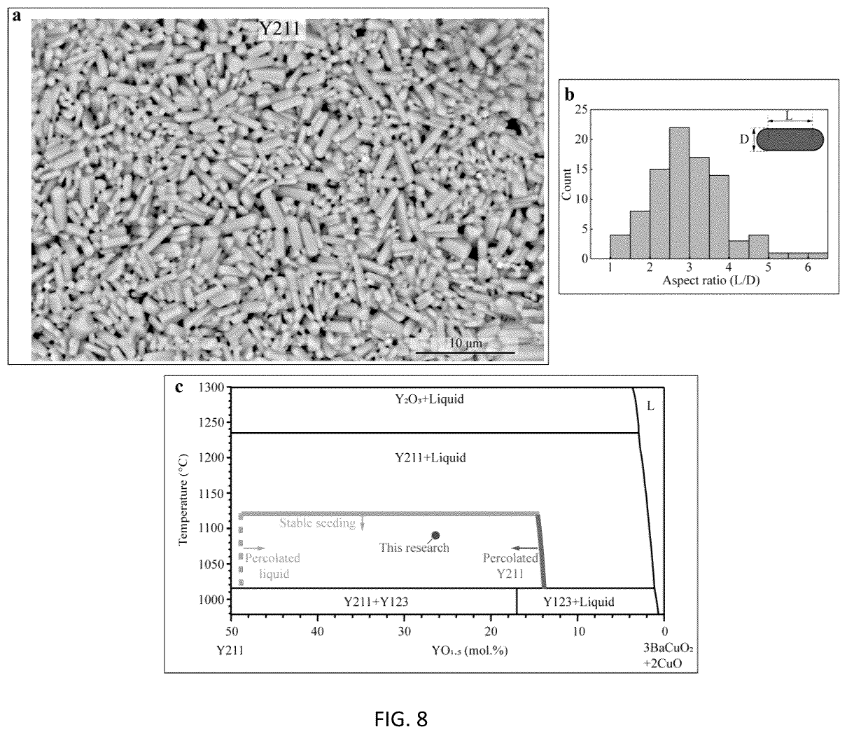

Remarkably, the 3D-printed micro-lattice maintains its original shape without slumping or collapsing, despite the large amount of liquid phase needed for single-crystal growth. According to percolation theory, an interconnected 3D solid skeleton starts to form when the volume fraction of jammed hard spheres is above 18.3%. This percolation threshold decreases when the solid particles are sphero-cylinders: White et al. found that silver nanowires with an aspect ratio of 8 in polystyrene composite have a percolation threshold of 8.3%. The solid Y211 particles exhibit both sphere and cylinder-like shapes on the surface of the lattice (FIG. 8), which is similar to the observation from quenching experiments above the peritectic temperature. If solid Y211 particles are inter-penetrable during sintering, a percolation threshold of 15.6% is obtained for an aspect ratio of 3 for the Y211 particles. From the vertical section of the Y₂O₃—BaO—CuO phase diagram (FIG. 8), the volume fraction of the solid Y211 phase is about 36% at the temperature of 1090° C. Therefore, a continuous Y211 skeleton can be expected to form above the peritectic temperature, thus preventing the slumping of the microlattice struts. In addition, various studies of top-seeded infiltration growth show that the (Ba,Cu)-rich liquid phase from a bottom liquid source can fully infiltrate upwards into an upper Y211 pellet, driven by capillary forces. Therefore, most of the wetting melt is expected to remain within the porous Y211 skeleton, enabling single-crystal growth without slumping or collapse of the 3D printed objects. Reports of 3D printed samples with partial liquid melt are found for other materials, such as liquid sintering in 3D printed micro-lattices and liquid infiltration in 3D printed porous preforms, suggesting that many other materials may be amenable to seeded single-crystal growth after 3D printing.

The XRD patterns shown in FIG. 2, (c) are collected on the top and bottom faces of the micro-lattice. Only the {001}family of peaks of the Y123 phase is observed, confirming that the samples are monocrystalline, with c-axis orientation. FIG. 2, (d) displays the IPF map and phase map near the center of the side face of the micro-lattice, showing that small Y211 particles are embedded in the Y123 matrix. The stitched IPF maps on the side face of the micro-lattice are shown in FIG. 2, (e). As the c-axis is aligned in the vertical direction, the side face shows the {100}/{010}orientation (however, the a and b axes cannot be differentiated from IPF maps due to their very close lattice parameter). A cubic unit cell (⅓ c) is used for indexing to avoid the mis-indexing problem caused by pseudo-symmetry between the a/b and ⅓ c axis of Y123. The stitched IPF maps and pole figure (FIG. 2, (e)) show that almost the whole lattice is successfully transformed into a single crystal. Three types of defects are also visible. First, some regions with low-angle crystallographic misorientation are visible in the IPF maps near the bottom and edges of the lattice. The complex geometry of the lattice implies that multiple growth fronts advance simultaneously along the struts, with some regions gradually accumulating some crystallographic misorientations. Second, the higher-magnification SEM-BSE micrograph in FIG. 2, (f) shows a few regions of porous Y211 phase located at the middle planes between vertical columns near the top of the lattice, where local growth fronts meet; these are most likely due to local solidification shrinkage of the Y123-forming melt. Lastly, a few horizontal cracks, ending at the porous Y211 planes, are visible in FIG. 2, (f). They are expected to be caused by different volume expansions in the a/b and c axis and an oxygen concentration gradient during the oxygenation of the Y123+Y211 micro-lattice. If these cracks adversely impact mechanical and superconductivity properties, they can be mitigated by Ag additions, an approach to be explored in future research.

### Superconducting Properties

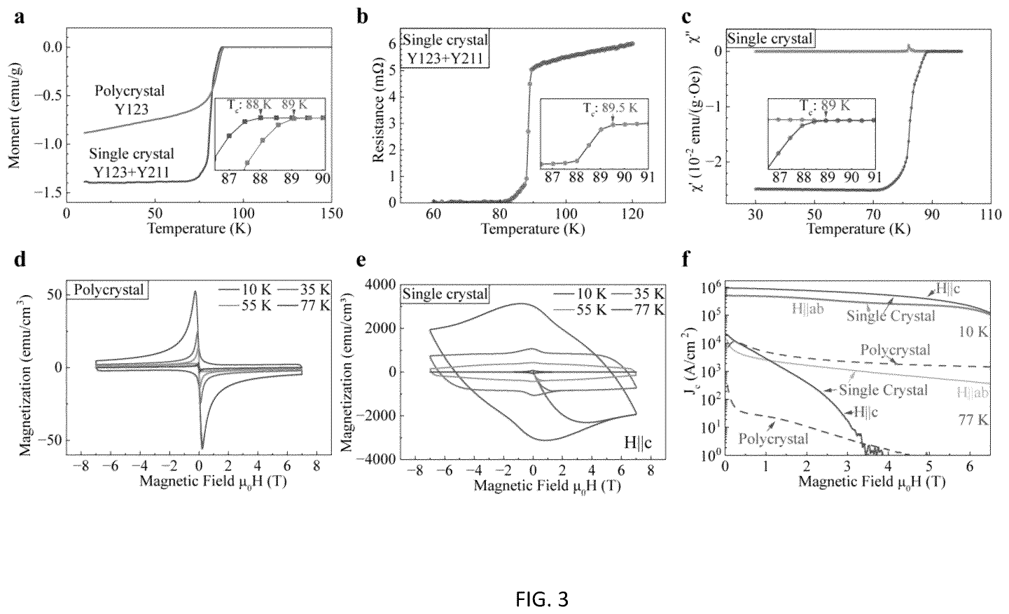

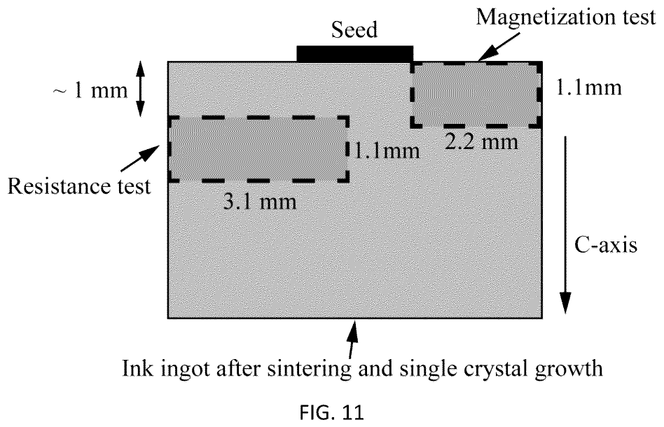

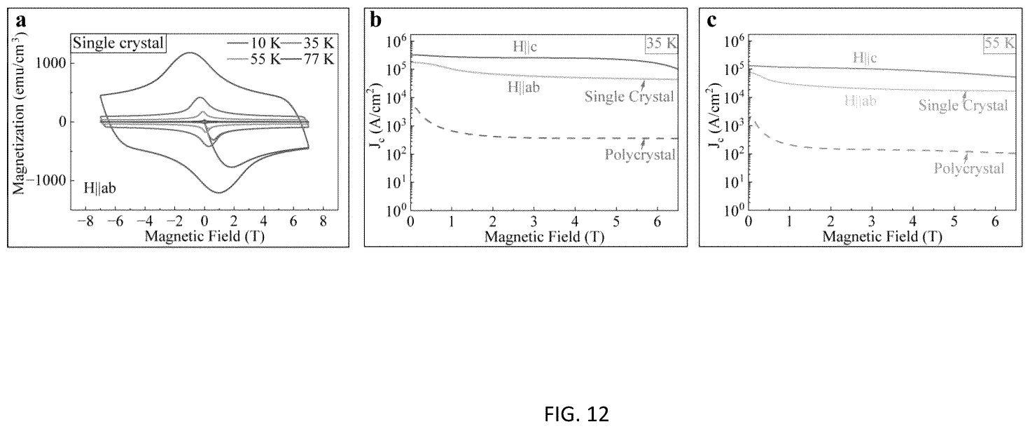

The superconducting properties of sintered ink-ingot samples, including critical transition temperature (T_{c}) from magnetization, resistance measurements, AC susceptibility, and critical current density (J_{c}), are shown in FIGS. 3 and 12 for polycrystalline Y123 and monocrystalline Y123+Y211. As shown in FIG. 3, (a), the poly- and monocrystalline samples exhibit nearly the same T_{c} values (T_{c}=89 and 88 K, respectively) from magnetization measurements. The resistance measurement for another monocrystalline sample shows a similar critical transition temperature (T_{c}=89.5 K) in FIG. 3, (b) and has a transition width of 8.5 K. The AC susceptibility measurement for the same monocrystalline sample shows a critical transition temperature of 89 K. These T_{c} values are about 3.5-5 K below the theoretical value (T_{c}=93 K). Measurement of impurities show the presence of seven elements, As (0.02 wt. %), B (0.014 wt. %), Ca (0.09 wt. %), Co (0.01 wt. %), Fe (0.01 wt. %), K (0.01 wt. %), and Ti (0.03 wt. %), which are known to deteriorate superconducting properties and are thus the likely reason for this lowered T_{c} value. Additively manufactured polycrystalline samples from other studies have shown a range of 86.5 K to 92 K for T_{c}, based on magnetization or transport measurements. Our single-crystal samples, with a T_{c} of 88-89.5 K, exhibit a similar critical temperature. The magnetization measurements (FIG. 3, (a)) reveal that the single-crystal sample exhibits a transition temperature about 1 K lower than that of the polycrystalline sample. One likely mechanism explaining this discrepancy is as follows. During the single-crystal growth process, the sample is held at 1090° C. for 1 hour, before cooling. This high-temperature step allows for the homogenization of possibly segregated impurities through accelerated diffusion in the liquid phase, which may facilitate the incorporation of some of the seven detected impurities into the crystal structure. Upon cooling, certain impurities may be expelled near the melt front; however, some residual impurities remain and are incorporated uniformly throughout the sample, which can lead to a slight reduction in the single crystal sample's critical temperature (T_{c}). The presence of small side peaks in the plot of the imaginary part of the complex magnetic susceptibility χ″ below T_{c} is consistent with the presence of imperfections, which may arise from regions with reduced superconducting transition regions because of impurities, misorientation, or non-uniform oxygenation. FIG. 3, (d) and (e) show the magnetization of polycrystal (pure Y123) and single-crystal samples, respectively. The polycrystal sample shows a much lower magnetization than that of the single-crystal sample. The width of the magnetization hysteresis loop in the vertical direction is related to the critical current density, which can be used to calculate the critical current density J_{c} according to the Bean model. The calculated values are plotted in FIG. 3, (f), which shows that the critical current density of single-crystal samples (2.1×10⁴ A·cm⁻², H∥c) is about 66 times higher than that of polycrystal samples (3.2×10² A·cm⁻²) at 77K for a near zero field, consistent with previous 3D printed polycrystal samples (about 5×10¹ A·cm⁻², 77K) and top seeded melt growth samples (about 4.5×10⁴ A·cm⁻², 77K, H∥c). At 10 K, the J_{c} of single-crystal samples (9.3×10⁵ A·cm⁻², H∥c) is about 180 times higher than that of polycrystal samples (5.2×10³ A·cm⁻²) for a near zero field. Effective elimination of the grain boundaries contributes to this high critical current density. Anisotropic behavior is also observed when the magnetic field is parallel with the c and a/b axis, as also reported in a directional solidified sample. The Y123-Y211 single crystal produced by the directional solidification method can exhibit a critical current density of 8.8×10⁴ A·cm⁻² at 77 K with H∥c in the self-field. This is of the same order of magnitude as the current density measured in our study. An epitaxial Y123-BaZrO₃ thin film (200-270 nm) produced by chemical solution deposition on an SrTiO₃ single crystal can achieve a critical current density of 4.5×10⁶ A·cm⁻² at 77 K with H∥c in the near self-field. The higher critical current density of the thin film is primarily attributed to its better c-axis alignment and a higher density of pinning centers. It should be noted that the tested samples are taken from an ink ingot after sintering and single-crystal growth, as shown in FIG. 11. The microlattice architectures or other complex structures may exhibit more misorientation compared to the ink ingot due to their intricate single-crystal growth paths and may thus show critical current density lower than that shown in FIG. 3, (f). Accurately measuring the upper critical magnetic field H_{c2} at low temperatures for the above samples would require a higher-field magnet, which exceeds the capabilities of the current facilities.

3D-Printed Objects with Complex Architectures:

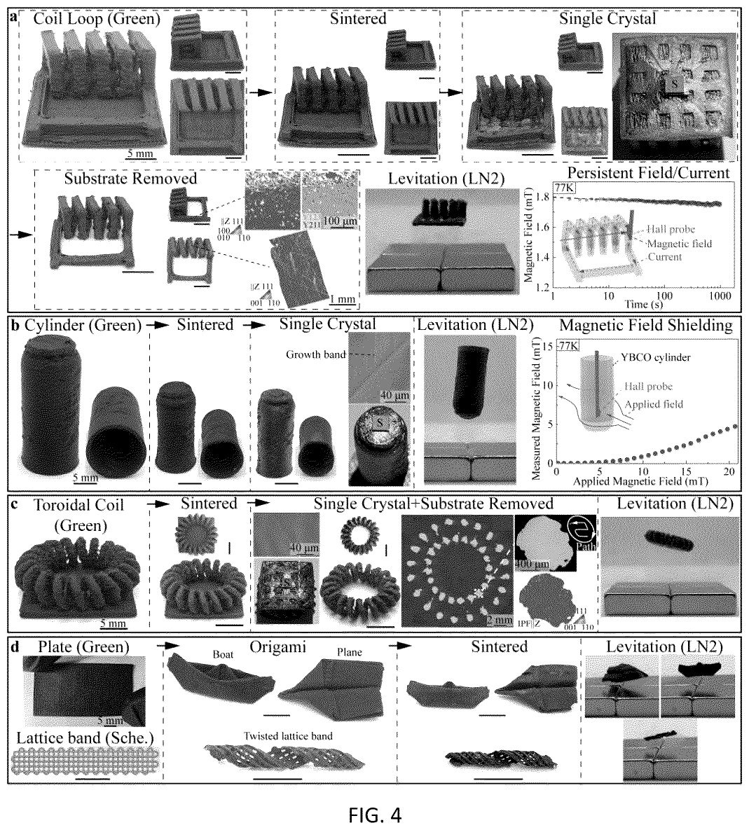

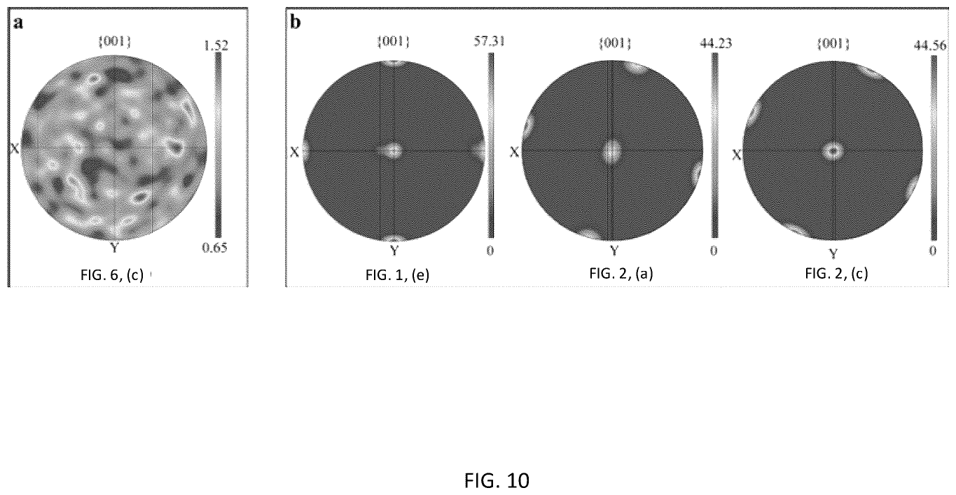

The ability to grow monocrystalline YBCO (Y123+Y211) superconductors from complex 3D-ink-printed polycrystalline parts is demonstrated in FIG. 4, (a)-(c). First, a horizontal coil with a closed loop is printed, sintered, and transformed into a single crystal (FIG. 4, (a)). The horizontal coil was printed on top of a printed substrate that has the same Y123-Y211 composition. After sintering, the entire sample, including the horizontal coil and substrate, is flipped so that the substrate faces upward. Then, the seed is placed on top of the substrate to allow subsequent single-crystal growth. The faceted growth sectors expand over the whole seeded surface, indicating complete single-crystal growth. After removing the substrate by grinding, the final 3D-ink-printed monocrystalline part is obtained. The IPF and Phase maps on the side view show that some surface regions with green color are from the Y211 phase and are localized near the sample surface (about 50 um). The IPF map and pole figures (FIG. 10) on the top view confirm that the single crystal grew from top to bottom. After immersing in liquid nitrogen, the coil can be levitated, consistent with T_{c}>77 K. A demonstration of the coil's ability to sustain a persistent current is also demonstrated at 77 K: the current is induced by switching off an external magnetic field (40 mT) along the axis of the horizontal coil (FIG. 13). A magnetic field of 1.8 mT generated from the persistent current (9.5 A or about 560 A·cm⁻²) is then detected and decays very slowly with time, following a logarithmic law. It should be noted that current may flow locally across the coil's cross-section; thus, the coil's persistent current may be lower than 9.5 A. The measurement was extended to 10,000 s (FIG. 13, (c)).

Second, FIG. 4, (b) shows a 3D-ink-printed tube, with a wall thickness of 600 mm and a closed-end, designed as a prototype for a shield protecting devices sensitive to external magnetic fields. Growth bands (or growth striations) indicative of singe-crystal growth are observed on the tube surface. At 77 K, the magnetic field (B) within the tube is found to be effectively shielded below 6 mT (B_{Applied}/B_{Measured}>28). An improved shielding performance could be obtained at lower temperatures, a thicker wall and/or a greater tube length.

FIG. 4, (c) demonstrates a 3D-printed toroidal coil, illustrating the versatility of our 3D-ink-printing method, as this architecture would be extremely difficult to achieve by other methods. Multiple closely printed strands form each layer of the looping wire. Single-crystal growth above the peritectic temperature enables full densification, with neither slumping nor void formation between these strands, as observed from SEM micrographs of cross-sections. Many 3D printed architectures, including coils, may originally not have appropriate seed crystal placement planes. However, FIG. 4, (a) and (c) demonstrate a route where these architectures still can be made monocrystalline by printing them on top of substrates (Y123-Y211), which are removed after single crystal growth. Therefore, our approach can be applied to most complex shapes.

Finally, as illustrated in FIG. 4, (d) for three miniature objects (airplane, boat, and twisted band), Origami folding of 3D-ink-printed lattice sheets or plates can easily be achieved because the PLGA-DCM ink system is mechanically flexible. After sintering, these polycrystalline demonstration objects retain their shape and levitate at 77 K above permanent magnets. The Origami (and related Kirigami) methods can be used to further increase the complexity of 3D-ink-printed samples, with the possibility of “fusing” overlapping, cut edges via addition of solvent.

This exemplary study shows a novel route combining two seemingly incompatible steps (i) 3D-ink extrusion printing+sintering and (ii) single crystal growth. This unlocks design freedom for single-crystal YBCO bulk objects and is applicable to a various rare-earth (La, Sm, Nd, Gd, Eu) barium copper oxide compositions. The underlying mechanism is explained by percolation theory where a percolated solid skeleton (Y211) supports the structure's integrity. This work demonstrates the compatibility of semi-solid single-crystal growth with additive manufacturing, suggesting a potential path toward a more universal method. Additionally, this approach could be explored and adapted to the additive manufacturing of other monocrystalline functional materials e.g., piezoelectrics, thermoelectrics, photovoltaics, and organic semiconductors.

Percolation threshold of Y₂BaCuO₅ (Y211) and liquid: The continuum percolation of inter-penetrable sphero-cylinders with different aspect ratios was simulated with Monte Carlo simulations by Xu et al., which gave an empirical approximation of the percolation threshold ∅_{c} from their simulation results:

$${∅}_{c} = 1 - {e}^{[ - \frac{C ( α )}{{V}_{dex}} ]}$$

$$C ( α ) = 1 + {( 0.136169 α + 0.165568 )}^{- 0.3235}$$

$${V}_{dex} = 2 + \frac{6 ( 1 + α ) ( 1 + 0.5 α )}{1 + 1.5 α}$$

where a=L/D.

The percolation through voids around cylindrical particles was simulated by Priour et al. The percolation threshold of voids (or liquid) around the cylindrical particles with an aspect ratio of a=3 is 4%. Therefore, a gray dotted line representing this percolation threshold for the liquid phase is shown in the Y₂O₃—BaO—CuO phase diagram, FIG. 8, (c).

### Effect of Impurity Elements:

Nine impurity elements, shown in Table 1, are present above the background level of 0.01 wt. %: As, B, Ca, Co, Fe, K, Na, Si, and Ti. Most of these impurities have a negative effect on the superconducting properties of Y123, as described below. These impurities (summing to 0.35 wt. %) are thus, very likely, the reason for a depressed T_{c} value of 88-89.5 K and a relatively low J_{c} (2.1×10⁴ A·cm⁻², H∥c), as shown in FIG. 3, compared with traditional Y123+Y211 fabricated by top-seeded melt growth.

1. Arsenic. A Y123 film grown on a MgO/GaAs substrate showed a relatively low T_{c} (89 K), with a relatively low critical current density J_{c} (4-6.7×10⁴ A·cm⁻² at 77K) compared with the Y123 grown on pure MgO (10⁶ A·cm⁻² at 77K). This was attributed to the contamination diffused or evaporated from the MgO/GaAs substrate.

2. Boron. The effect of B has been studied by adding B₂O₃ powders to a Y123 sample. The addition of 0.05 wt. % of B₂O₃(B: 0.016 wt. %) decreases T_{c} by about 1.6 K and decreases the critical current density from 1.6 to 1.2×10⁴ A·cm⁻² at 50 K under self-field. The B content in our sample is 0.014 wt. %, similar to the above value.

3. Calcium. Addition of Ca into a Y123 thin film was detrimental to T_{c} and J_{C} by cation substitution of Y³⁺ with Ca²⁺ and formation of oxygen vacancies. An about 0.30 wt. % Ca concentration decreases T_{c} to 80-85 K and depresses J_{C} by four orders of magnitude, from about 10⁶ A·cm⁻² (Ca free) to about 10⁵ A·cm⁻² at 77 K under self-field. The Ca content (0.09 wt. %) in our sample is one third of the above value of 0.30 wt. %, but still very likely to lower T_{c} and J_{c}.

4. Cobalt. Addition of about 0.18 wt. % Co in Y123 decrease its T_{c} by about 1 K.

5. Iron. Addition of about 0.02 wt. % Fe in Y123 leads a T_{c} of 87-90 K. Our Fe content (0.01 wt. %) is half the above value.

6. Potassium. Addition of ˜0.01 wt. % K in Y123 decreased T_{c} by about 0.5 K. We have the same K content (0.01 wt. %).

7. Sodium: Y123 with 0.24 wt. % Na shows a limited effect on the onset of superconducting transition temperature T_{c}. The value of J_{c} is also not apparently depressed by 0.24 wt. % Na in Y123. Therefore, 0.06 wt. % Na in our samples is not expected to affect superconducting properties.

8. Silicon. The addition of 0.1 to 0.5 wt. % SiO₂(Si: 0.05 to 0.23 wt. %) has a limited effect on T_{c}. Also, the addition of 0.09 wt. % Si did not cause an apparent drop in critical current densities under a self-field.

9. Titanium. Y123 with 0.36 wt. % Ti shows a strongly reduced value of T_{c} of 76 K. Our sample has a much lower Ti content (0.03 wt. %) but Ti may still contribute to a lower T_{c}.

TABLE 1
Impurity element concentrations (as measured from ICP-AES)
for Y123-Y211 samples sintered at 1000° C. for 20 h.

| Element | As | B | Ca | Co | Fe | K | Na | Si | Ti |
|---|---|---|---|---|---|---|---|---|---|
| wt. % | 0.02 | 0.014 | 0.09 | 0.01 | 0.01 | 0.01 | 0.06 | 0.11 | 0.03 |

other elements tested (<0.01 wt. %): Al, Be, Bi, Cd, Cr, Dy, Er, Eu, Ga, Ge, Gd, Hf, Ho, In, La, Li, Lu, Mg, Mn, Mo, Nb, Nd, Ni, P, Pb, Pr, Rb, Re, Sb, Sc, Se, Sm, Sn, Sr, Ta, Tb, Te, Th, Tl, Tm, U, V, W, Yb, Zn, Zr

### Current and Flux Creep in the Coil Loop:

Here, we assume that the measured magnetic field comes from a persistent current along the path of the horizontal coil rather than from microscopic current vortices. Each turn of the coil is simplified as a square loop. The magnetitic field B(x) generated from a square loop along its normal axis is given by:

$$B ( x ) = \frac{{μ}_{0} I}{4 π} {l}^{2} {( {x}^{2} + \frac{{l}^{2}}{4} )}^{- 1} {( {x}^{2} + \frac{{l}^{2}}{2} )}^{- \frac{1}{2}}$$

where μ₀ is the vacuum magnetic permeability, I is current, l is the width of the square loop, and x is the distance to the center of the square loop. The width for each square loop is 4 mm. The distance between each turn of the coil and Hall probe are 11.6, 8.7, 5.9, 2.6, and 0 mm. The initial measured magnetic field is 1.8 mT. Therefore, the current in the coil is calculated as 9.5 A or ˜560 A·cm⁻². A higher persistent current in the coil can be achieved by using flux pumping.

The logarithmic decay of the measured magnetic field is due to the magnetic flux creep, which can be fitted with:

$$B ( x ) = a - bln \frac{t}{{t}_{0}}$$

where t is time and t₀ is the unit of time. Fitting of data shown in FIG. 4, (a) before adding LN2 during measurement (1000 s) provides the following parameters: a=18.0 G, b=0.067 G. Therefore, the time to lose 1% of the original value is 15 s and the time to lose 5% of the original value is 189 h. Rong et al. studied the logarithmic decay of magnetic field for YBCO closed loops made by cutting middle slits on YBCO coated tapes. They found that the time to lose 1% of the original value was 126 s. A higher critical current density (stronger flux pinning force) of these YBCO-coated tapes is the possible reason for their lower decaying rate.

In sum, this invention discloses, among other things, a novel approach to grow a single crystal from a 3D-ink-printed YBCO architectures (with or without additional Origami folding) with an excellent shape fidelity to achieve nearly hundred-fold improvement in critical current density as compared to prior polycrystalline YBCO objects created by AM.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described to explain the principles of the invention and their practical application to enable others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

Some references, which may include patents, patent applications, and various publications, are cited and discussed in the description of this invention. The citation and/or discussion of such references is provided merely to clarify the description of the invention and is not an admission that any such reference is “prior art” to the invention described herein. All references cited and discussed in this specification are incorporated herein by reference in their entireties and to the same extent as if each reference was individually incorporated by reference.

### LIST OF REFERENCES

[1]. Wu M K, et al. Superconductivity at 93 K in a new mixed-phase Y—Ba—Cu—O compound system at ambient pressure. Phys Rev Lett 58, 908-910 (1987).
[2]. Molodyk A, et al. Development and large volume production of extremely high current density YBa₂Cu₃O₇ superconducting wires for fusion. Sci Rep 11, 2084 (2021).
[3]. Namburi D K, Shi Y, Cardwell D A. The processing and properties of bulk (RE)BCO high temperature superconductors: current status and future perspectives. Supercond Sci Technol 34, 053002 (2021).
[4]. Durrell J, et al. The behavior of grain boundaries in the Fe-based superconductors. Rep Prog Phys 74, 124511 (2011).
[5]. Zhang B, et al. Efficient Fabrication of Ultralight YBa₂Cu₃O₇₋ₓ Superconductors with Programmable Shape and Structure. Adv Funct Mater 31, 2100680 (2021).
[6]. Namburi D K, Shi Y, Palmer K G, Dennis A R, Durrell J H, Cardwell D A. A novel, two-step top seeded infiltration and growth process for the fabrication of single grain, bulk (RE)BCO superconductors. Supercond Sci Technol 29, 095010 (2016).
[7]. Dam B, et al. Origin of high critical currents in YBa₂Cu₃O_{7-δ} superconducting thin films. Nature 399, 439-442 (1999).
[8]. Richter S C, et al. JACoW: Bending Radius Limits of Different Coated REBCO Conductor Tapes—An Experimental Investigation with Regard to HTS Undulators. JACoW IPAC 21, 3837-3840 (2021).
[9]. Shin H S, Nisay A, Leon M Bd, Dedicatoria M J. Joining of REBCO Coated Conductor Tapes Using Ultrasonic Welding Method. IEEE Transactions on Applied Superconductivity 25, 1-5 (2015).
[10]. Ahn D, et al. Biaxially Textured YBa₂Cu₃O₇₋ₓ Microwave Cavity in a High Magnetic Field for a Dark-Matter Axion Search. Physical Review Applied 17, L061005 (2022).
[11]. Namburi D K, Shi Y, Dennis A R, Durrell J H, Cardwell D A. A robust seeding technique for the growth of single grain (RE)BCO and (RE)BCO-Ag bulk superconductors. Supercond Sci Technol 31, 044003 (2018).
[12]. Grilli F, et al. Superconducting motors for aircraft propulsion: the Advanced Superconducting Motor Experimental Demonstrator project. Journal of Physics: Conference Series 1590, 012051 (2020).
[13]. Jensen B B, Mijatovic N, Abrahamsen A B. Development of superconducting wind turbine generators. Journal of Renewable and Sustainable Energy 5, (2013)
[14]. Jakus A E, Taylor S L, Geisendorfer N R, Dunand D C, Shah R N. Metallic Architectures from 3D-Printed Powder-Based Liquid Inks. Adv Funct Mater 25, 6985-6995 (2015)
[15]. Lewis J A, Smay J E, Stuecker J, Cesarano J. Direct Ink Writing of Three-Dimensional Ceramic Structures. J Am Ceram Soc 89, 3599-3609 (2006).
[16]. Chen Z, et al. 3D printing of ceramics: A review. J Eur Ceram Soc 39, 661-687 (2019).
[17]. Lv X, Ye F, Cheng L, Fan S, Liu Y. Binder jetting of ceramics: Powders, binders, printing parameters, equipment, and post-treatment. Ceram Int 45, 12609-12624 (2019).
[18]. Meier C, Weissbach R, Weinberg J, Wall W A, Hart A J. Critical influences of particle size and adhesion on the powder layer uniformity in metal additive manufacturing. J Mater Process Technol 266, 484-501 (2019).
[19]. Wei X, Peng E, Xie Y, Xue J, Wang J, Ding J. Extrusion printing of a designed three-dimensional YBa₂Cu₃ O₇₋ₓ superconductor with milled precursor powder. Journal of Materials Chemistry C 5, 3382-3389 (2017).
[20]. Wei X, Nagarajan R S, Peng E, Xue J, Wang J, Ding J. Fabrication of YBa₂Cu₃O₇₋ₓ (YBCO) superconductor bulk structures by extrusion freeforming. Ceram Int 42, 15836-15842 (2016).
[21]. Mendes D, et al. Low-cost and high-performance 3D printed YBCO superconductors. Ceram Int 47, 381-387 (2021).
[22]. Zhang B, Zhang X, Zhou Y-H. Lightweight, highly tough and durable YBa₂Cu₃O₇₋ₓ superconductor. National Science Review 10, (2023).
[23]. Ma Y, Zhang B, Zhang X, Zhou Y-H. Controllable rectification on the thermal conductivity of porous YBa₂Cu₃O₇₋ₓ superconductors from 3D-printing. Int J Extreme Manuf 5, 015001 (2023).
[24]. Coveney A, Morrison K, Engstrøm D. DC Resistance Measurements in Multi-Layer Additively Manufactured Yttrium Barium Copper Oxide Components. Adv Eng Mater, 2300773 (2023).
[25]. Geisendorfer N R, Shah R N. Effect of Polymer Binder on the Synthesis and Properties of 3D-Printable Particle-Based Liquid Materials and Resulting Structures. ACS Omega 4, 12088-12097 (2019).
[26]. Peitola K, Karppinen M, Rundlöf H, Tellgren R, Yamauchi H, Niinistö L. Structural changes related to changes in oxygen stoichiometry in the Ba_{1-y}CuO_{2+δ}·(CO2)ₓ system as determined by powder X-ray and neutron diffraction. J Mater Chem 9, 2599-2603 (1999).
[27]. Krabbes G, Fuchs G, Canders W-R, May H, Palka R. High temperature superconductor bulk materials. NJ, Hoboken: Wiley-VCh Darmstadt, (2006).
[28]. Zhai W, Shi Y, Durrell J H, Dennis A R, Cardwell D A. The Influence of Y-211 Content on the Growth Rate and Y-211 Distribution in Y—Ba—Cu—O Single Grains Fabricated by Top Seeded Melt Growth. Crystal Growth & Design 14, 6367-6375 (2014).
[29]. Piñol S, et al. Enhanced critical currents by CeO₂ additions in directionally solidified YBa₂Cu₃O₇. Appl Phys Lett 65, 1448-1450 (1994).
[30]. Kim C-J, et al. Formation of BaCeO₃ and its influence on microstructure of sintered/melt-textured Y—Ba—Cu—O oxides with CeO₂ addition. J Mater Res 9, 1952-1960 (1994).
[31]. Powell M J. Site percolation in randomly packed spheres. Physical Review B 20, 4194-4198 (1979).
[32]. White S I, et al. Electrical Percolation Behavior in Silver Nanowire-Polystyrene Composites: Simulation and Experiment. Adv Funct Mater 20, 2709-2716 (2010).
[33]. Kim C-J, et al. Formation of BaCeO₃ and its influence on microstructure of sintered/melt-textured Y—Ba—Cu—O oxides with CeO₂ addition. J Mater Res 9, 1952-1960 (1994).
[34]. Zhang D, Kenel C, Dunand D C. Microstructure and mechanical properties of 3D ink-extruded CoCrCuFeNi microlattices. Acta Mater 238, 118187 (2022).
[35]. Kenel C, Al Malki M M F, Dunand D C. Microstructure evolution during reduction and sintering of 3D-extrusion-printed Bi₂O₃+TeO₂ inks to form Bi₂Te₃. Acta Mater 221, 117422 (2021).
[36]. Zhang D, Kenel C, Caccia M, Sandhage K H, Dunand D C. Complex-shaped, finely-featured ZrC/W composites via shape-preserving reactive melt infiltration of porous WC structures fabricated by 3D ink extrusion. Additive Manufacturing Letters 1, 100018 (2021).
[37]. Zhai W, et al. The processing and properties of single grain Y—Ba—Cu—O fabricated from graded precursor powders. Supercond Sci Technol 26, 125021 (2013).
[38]. Weigand M, et al. Individual grain boundary properties and overall performance of metal-organic deposition coated conductors. Physical Review B 81, 174537 (2010).
[39]. Konstantopoulou K, Shi Y H, Dennis A R, Durrell J H, Pastor J Y, Cardwell D A. Mechanical characterization of GdBCO/Ag and YBCO single grains fabricated by top-seeded melt growth at 77 and 300 K. Supercond Sci Technol 27, 115011 (2014)
[40]. Galluzzi A, et al. Pinning Energy and Evidence of Granularity in the AC Susceptibility of an YBa₂Cu₃O₇₋ₓ Superconducting Film. Applied Sciences 14, 4379 (2024).
[41]. Güçlü N, Yegilkanat C M, Ağil H, Doğan F, Gencer A, Kölemen U. Low Field AC Susceptibility Study of YBCO Prepared by Top Seeded Melt Growth. Journal of Superconductivity and Novel Magnetism 24, 261-264 (2011).
[42]. Chen D X, Goldfarb R B. Kim model for magnetization of type-II superconductors. J Appl Phys 66, 2489-2500 (1989).
[43]. Bean C P, Doyle M V, Pincus A G. Synthetic High-Field, High-Current Superconductor. Phys Rev Lett 9, 93-94 (1962).
[44]. Salama K, Lee D F, Presswood R G, Francavilla T. Seeded directional solidification of YBa₂Cu₃Oₓ superconductors. Physica C: Superconductivity 235-240, 213-216 (1994).
[45]. Mogro-Campero A, Turner L G, Hall E L. Large differences of critical current density in thin films of superconducting YBa₂Cu₃O₇₋ₓ. J Appl Phys 65, 4951-4954 (1989).
[46]. Civale L, et al. Understanding High Critical Currents in YBa2Cu3O7 Thin Films and Coated Conductors. J Low Temp Phys 135, 87-98 (2004).
[47]. Klapper H. Generation and Propagation of Defects During Crystal Growth. In: Springer Handbook of Crystal Growth (eds Dhanaraj G, Byrappa K, Prasad V, Dudley M). Springer Berlin Heidelberg (2010).
[48]. Wéra L, Fagnard J F, Namburi D K, Shi Y, Vanderheyden B, Vanderbemden P. Magnetic Shielding Above 1 T at 20 K With Bulk, Large Grain YBCO Tubes Made by Buffer-Aided Top Seeded Melt Growth. IEEE Transactions on Applied Superconductivity 27, 1-5 (2017).
[49]. Denis S, et al. Magnetic shielding properties of high-temperature superconducting tubes subjected to axial fields. Supercond Sci Technol 20, 192 (2007).
[50]. Kang S-J L, Park J-H, Ko S-Y, Lee H-Y. Solid-State Conversion of Single Crystals: The Principle and the State-of-the-Art. J Am Ceram Soc 98, 347-360 (2015)
[51]. Zhao L-D, et al. Ultrahigh power factor and thermoelectric performance in hole-doped single-crystal SnSe. Science 351, 141-144 (2016).
[52]. Funahashi R, Matsubara I, Ikuta H, Takeuchi T, Mizutani U, Sodeoka S. An Oxide Single Crystal with High Thermoelectric Performance in Air. Jpn J Appl Phys 39, L1127 (2000).
[53]. Yakunin S, et al. Detection of gamma photons using solution-grown single crystals of hybrid lead halide perovskites. Nature Photonics 10, 585-589 (2016)
[54]. Minemawari H, et al. Inkjet printing of single-crystal films. Nature 475, 364-367 (2011).
[55]. Volochová D, Kavec̆anský V, Antal V, Diko P, Yao X. Thermal stability of NdBCO/YBCO/MgO thin film seeds. Supercond Sci Technol 29, 044004 (2016).
[56]. Xu W, Su X, Jiao Y. Continuum percolation of congruent overlapping spherocylinders. Physical Review E 94, 032122 (2016).
[57]. Priour D J, McGuigan N J. Percolation through Voids around Randomly Oriented Polyhedra and Axially Symmetric Grains. Phys Rev Lett 121, 225701 (2018).
[58]. Krauns C, Sumida M, Tagami M, Yamada Y, Shiohara Y. Solubility of RE elements into Ba—Cu—O melts and the enthalpy of dissolution. Zeitschrift für Physik B Condensed Matter 96, 207-212 (1994).
[59]. Xiang H, et al. Film thermal stability correlation with seeding modes in the growth of YBa₂Cu₃O7-6 crystals. J Appl Crystallogr 49, 873-879 (2016).
[60]. L. D. Chang, M. Z. Tseng, E. L. Hu, D. K. Fork, Epitaxial MgO buffer layers for YBa₂Cu₃O₇₋ₓ thin film on GaAs, Appl. Phys. Lett. 60(14) (1992) 1753-1755.
[61]. U. Topal, H. Ozkan, Effects of B₂O₃ addition on the properties of melt-processed YBa₂Cu₃O_{7-δ}, Supercond. Sci. Technol. 18(1) (2005) 82.
[62]. A. Augieri, T. Petrisor, G. Celentano, L. Ciontea, V. Galluzzi, U. Gambardella, A. Mancini, A. Rufoloni, Effect of Ca doping in YBCO superconducting thin films, Physica C: Superconductivity 401(1) (2004) 320-324.
[63]. L. Liu, C. Dong, J. Zhang, J. Li, The microstructure study of Co-doped YBCO system, Physica C: Superconductivity 377(3) (2002) 348-356.
[64]. X. Yao, A. Oka, T. Izumi, Y. Shiohara, Crystal growth and superconductivity of Fe-doped YBCO single crystals, Physica C: Superconductivity 339(2) (2000) 99-105.
[65]. C. S. Tan, M. M. Awang Kechik, N. A. Che Dzulkifli, S. I. Sukor, A. N. Kamarudin, S. H. Yap, H. Baqiah, M. K. A. Karim, S. K. Chen, K. P. Lim, K. K. Mohd Shariff, S. A. Halim, Effect of concentration of potassium added in Y1Ba2Cu3O7-δ superconductor by using the thermal treatment method, AIP Conference Proceedings 2619(1) (2023).
[66]. X. W. Zou, Z. H. Wang, H. Zhang, The peak effect observed in the Na substituted melt textured growth YBCO, Physica C: Superconductivity 356(1) (2001) 39-45.
[67]. M. K. Ben Salem, E. Hannachi, Y. Slimani, A. Hamrita, M. Zouaoui, L. Bessais, M. Ben Salem, F. Ben Azzouz, SiO2 nanoparticles addition effect on microstructure and pinning properties in YBa2Cu3Oy, Ceram. Int. 40(3) (2014) 4953-4962.
[68]. M. Sahoo, D. Behera, Effect of Ti Doping on Structural and Superconducting Property of YBa2Cu3O7-yHigh TcSuperconductor, Journal of Superconductivity and Novel Magnetism 27(1) (2014) 83-93.
[69]. Garretson, Craig M. “A combined form of the laws of Ampere and Biot-Savart.” American Journal of Physics 54.3 (1986): 253-258.
[70]. C. Hoffmann, D. Pooke and A. D. Caplin, “Flux Pump for HTS Magnets,” in IEEE Transactions on Applied Superconductivity, vol. 21, no. 3, pp. 1628-1631, June 2011, doi: 10.1109/TASC.2010.2093115.
[71]. Anderson, Philip W., and Y. B. Kim. “Hard superconductivity: theory of the motion of Abrikosov flux lines.” Reviews of modern physics 36.1 (1964): 39.
[72]. Rong C C, Barnes P N, Levin G A, Miller J D, Santosusso D J, Fitzpatrick B K. Investigation of the Relaxation of Persistent Current in Superconducting Closed Loops Made Out of YBCO Coated Conductors. IEEE Transactions on Applied Superconductivity 25, 1-5 (2015).

What is claimed is:

1. A method for fabricating a monocrystalline superconductor, comprising:
providing an ink comprising a mixture of powders of RE₂O₃, BaCO₃, and a Ba and/or Cu precursor with a binder and a solvent;
extruding the ink into micro-lattices layer by layer to form a three dimension (3D)-printed object with a desired architecture;
sintering the 3D-printed object to obtain a polycrystalline 3D-printed object comprising REBa₂Cu₃O₇₋ₓ(RE123)+RE₂BaCuO₅(RE211); and
performing single-crystal growth of monocrystalline structures from the polycrystalline 3D-printed object to fabricate the monocrystalline superconductor,
wherein RE represents a rare-earth element selected from the group consisting of Y, La, Sm, Nd, Gd, and Eu.

2. The method of claim 1, wherein the Ba- and/or Cu-precursor comprises CuO, BaO, Cu₂O, CuCO₃·Cu(OH)₂, Cu₂(OH)₃Cl, CuCl₂, CuNO₃, CuSO₄, or a combination thereof.

3. The method of claim 2, wherein the ink comprises a composition of RE123+(10-50) wt. % RE211+(0-5) wt. % (CeO₂ or Pt) formed by mixing powders of RE₂O₃, BaCO₃, the Ba and/or Cu precursor, and (CeO₂ or Pt) with the binder and the solvent.

4. The method of claim 3, wherein the ink composition comprises 69 wt. % REBa₂Cu₃O₇₋ₓ+30 wt. % RE₂BaCuO₅+1 wt. % CeO₂.

5. The method of claim 1, further comprising performing rapid evaporation of the solvent after said extruding the ink to prevent slumping and sagging of printed filaments in the 3D-printed object.

6. The method of claim 1, wherein the binder comprises poly-lactic-co-glycolic-acid (PLGA), or polystyrene (PS), or polyethylene oxide (PEO), and the solvent comprises dichloromethane (DCM).

7. The method of claim 1, wherein the ink further comprises a plasticizer and/or a surfactant.

8. The method of claim 7, wherein the plasticizer comprises dibutyl phthalate (DBP), and the surfactant comprises ethylene glycol butyl ether (EGBE).

9. The method of claim 7, wherein said sintering the 3D-printed object comprises:
de-binding the 3D-printed object at temperature in a range of 100-400° C. under flowing Ar-1 mol. % O₂; and
heating the de-bonded 3D-printed object at temperature in a range of 750-1100° C. under flowing O₂.

10. The method of claim 9, wherein said de-binding the 3D-printed object comprises:
evaporation of the solvent and the surfactant at temperature of 100-200° C. for 0.2-2 h; and
decomposition of the binder at temperature of 200-400° C. for 0.2-2 h,
wherein the heating and cooling rates are 0.1-10° C./min.

11. The method of claim 9, wherein said heating the de-bonded 3D-printed object comprises:
heating the de-bonded 3D-printed object first at temperature of 750-950° C. for 5-15 h with a heating rate of 1-2° C./min, and then up to temperature of 1100° C. for 15-25 h with a heating rate of 10° C./min and a cooling rate of 1-2° C./min, so as to obtain the additively manufactured object.

12. The method of claim 1, wherein said performing the single-crystal growth utilizes a monocrystalline seed to grow the monocrystalline structures from the polycrystalline 3D-printed object via a melt growth process, which transforms the 3D-printed micro-lattices from polycrystal to monocrystal.

13. The method of claim 12, wherein the monocrystalline seed comprises a MgO substrate a REBCO thin film, and/or a REBa₂Cu₃O₇₋ₓ thin film.

14. The method of claim 12, wherein said performing the single-crystal growth comprises:
heating the polycrystalline 3D-printed object above its peritectic temperature to decompose the RE123 phase to the RE211+(Ba,Cu-rich) liquid phase; and
cooling the RE211+(Ba,Cu-rich) liquid phase at a very slow rate (0.1-1 K/h) which, upon crossing the peritectic temperature, triggers single-crystal growth initiated from a REBa₂Cu₃O₇₋ₓ single-crystal thin film seed.

15. The method of claim 12, wherein the polycrystalline 3D-printed object is heated at temperature of 1050-1120° C. for 1 h with a heating rate of 100° C./h; cooled to temperature of 1015-1005° C. with a cooling rate of 50° C./h; cooled to temperature of 985-995° C. with a cooling rate of 0.1-1° C./h; held at 985-995° C. for 10 h; and cooled to room temperature with a cooling rate of 1-2° C./min, under dry air flow.

16. The method of claim 12, wherein geometric details of the 3D-printed object survive the melt growth process, without slumping, sagging or collapse.

17. The method of claim 16, wherein the 3D-printed object has an excellent shape fidelity to achieve a nearly hundred-fold improvement in the critical current density as compared to existing polycrystalline YBCO objects created by AM.

18. A monocrystalline superconductor, comprising:
monocrystalline structures grown from an additively manufactured object with desired architecture, wherein the additively manufactured object comprises a polycrystalline 3D-printed object comprising REBa₂Cu₃O₇₋ₓ(RE123)+RE₂BaCuO₅ (RE211), wherein RE represents a rare-earth element selected from the group consisting of Y, La, Sm, Nd, Gd, and Eu.

19. The superconductor of claim 18, wherein the additively manufactured object is formed by:
extruding an ink into micro-lattices layer by layer to form a three dimension (3D)-printed object with a desired architecture, wherein the ink comprises a mixture of powders of RE₂O₃, BaCO₃, and a Ba and/or Cu precursor with a binder and a solvent;
sintering the 3D-printed object to obtain a polycrystalline 3D-printed object comprising REBa₂Cu₃O₇₋ₓ (RE123)+RE₂BaCuO₅(RE211).

20. The superconductor of claim 19, wherein the Ba- and/or Cu-precursor comprises CuO, BaO, Cu₂O, CuCO₃·Cu(OH)₂, Cu₂(OH)₃Cl, CuCl₂, CuNO₃, CuSO₄, or a combination thereof.

21. The superconductor of claim 19, wherein the ink comprises a composition of RE123+(10-50) wt. % RE211+(0-5) wt. % (CeO₂ or Pt) formed by mixing powders of RE₂O₃, BaCO₃, the Ba and/or Cu precursor, and (CeO₂ or Pt) with the binder and the solvent.

22. The superconductor of claim 18, wherein the additively manufactured object includes a horizontal coil, a toroidal coil, a hollow cylinder, an Origami object, a Kirigami object, a lattice band object, or a combination thereof.

23. The superconductor of claim 18, wherein the monocrystalline structures are grown from the additively manufactured object by utilizing a monocrystalline seed to grow the monocrystalline structures from the polycrystalline 3D-printed object via a melt growth process, which transforms the 3D-printed micro-lattices from polycrystal to monocrystal.

24. The superconductor of claim 23, wherein the desired architecture of the 3D-printed object survives the melt growth process, without slumping, sagging or collapse.

25. The superconductor of claim 23, wherein the 3D-printed object has an excellent shape fidelity to achieve a nearly hundred-fold improvement in a critical current density as compared to existing polycrystalline YBCO objects created by AM.

26. The superconductor of claim 18, wherein the superconductor has a critical current density J_{c} of about 2.1×10⁴ A/cm², and a critical temperature T_{c} of about 88-89.5 K.
